(19) United States
(12) Patent Application Publication
(10) Pub. No.: US 2026/0231250 A1
(43) Pub. Date: Aug. 6, 2026

(54) CLOUD NATIVE SUPPORT NETWORK SLICING METHOD

(71) Applicant: ELECTRONICS AND TELECOMMUNICATIONS RESEARCH INSTITUTE, Daejeon (KR)

(72) Inventors: Seung Han CHOI, Daejeon (KR); Nam Seok KO, Daejeon (KR)

(73) Assignee: ELECTRONICS AND TELECOMMUNICATIONS RESEARCH INSTITUTE, Daejeon (KR)

(21) Appl. No.: 19/530,565

(22) Filed: Feb. 5, 2026

(30) Foreign Application Priority Data
Feb. 6, 2025 (KR) 10-2025-0015262
Apr. 16, 2025 (KR) 10-2025-0049671
Oct. 29, 2025 (KR) 10-2025-0158603

(51) Int. Cl. H04W 76/10; H04W 48/18

(52) U.S. Cl. CPC H04W 76/10; H04W 48/18

(57) ABSTRACT

Provided is a method which establishes a protocol data unit (PDU) session. The method includes receiving, by a session management function (SMF), a PDU session generation request message from an access management function (AMF), the PDU session generation request message including computing capability-related information, selecting, by the SMF, a policy control function (PCF) and at least one user plane function (UPF) based on a PDU session establishment request to perform an associated procedure, and delivering associated PDU session information to a terminal via a base station.

### CROSS-REFERENCE TO RELATED APPLICATIONS

This application claims priority under 35 U.S.C. § 119 to Korean Patent Application No. 10-2025-0015262 filed on Feb. 6, 2025, No. 10-2025-0049671 filed on Apr. 16, 2025, No. 10-2025-0158603 filed on Oct. 29, 2025 in the Korean Intellectual Property Office, the disclosures of which are incorporated by reference herein in their entireties.

### BACKGROUND

Embodiments of the present disclosure described herein relate to a method and an apparatus for managing a protocol data unit (PDU) session in a mobile communication system. In detail, embodiments of the present disclosure described herein relate to a method and an apparatus for managing a PDU session with regard to a computing capability. Furthermore, embodiments of the present disclosure described herein relate to a method and an apparatus for allocating a slice including cloud native metadata.

As a new service, such as 5th generation (5G) or an Internet of things (IoT), emerges, a future application service requires a network technology for providing a stronger programming possibility and a simpler integrated network solution. 5G has been developed based on a service scenario of enhanced mobile broadband (eMBB), massive machine type communication (mMTC), and ultra-reliable low latency (uRLLC).

However, there has been an increase in needs for various types of service provision. An existing architecture alone may have a limitation in providing a complex service. Considering the above points, a service-based architecture (SBA) may be considered as a new architecture. As an example, an SBA network may integrate advanced technologies, such as network function virtualization (NFV), software-defined networking (SDN), multi-access edge computing (MEC), and network slicing.

Furthermore, services which are newly introduced in the future, such as 6th generation (6G), may be services requiring a high computing capability. There may be a need for a method for managing a PDU session with regard to it. A description will be given below of it.

### SUMMARY

Embodiments of the present disclosure provide a method and an apparatus for managing a PDU session.

Embodiments of the present disclosure provide a method and an apparatus for managing a PDU session with regard to a computing capability.

Embodiments of the present disclosure provide a method and an apparatus for allocating a network slice including cloud native metadata.

Embodiments of the present disclosure provide a method and an apparatus for allocating a network slice requiring a high-performance computing capability.

The technical purposes which the present disclosure is intended for are not limited to the technical purposes set forth above. Other technical purposes not mentioned may be clearly understood by those skilled in the art to which the present invention belongs from the following description.

According to an embodiment, a method for establishing a protocol data unit (PDU) session may include receiving, by a session management function (SMF), a PDU session generation request message from an access management function (AMF), the PDU session generation request message including high-performance computing capability request information, selecting, by the SMF, a policy control function (PCF) and at least one user plane function (UPF) based on a PDU session establishment request to perform an association procedure, and delivering, by the SMF, associated PDU session information to a terminal via a base station.

Furthermore, according to an embodiment, an apparatus for performing a protocol data unit (PDU) session establishment may include a memory storing at least one program, a transceiver that transmits and receives at least one signal, and a processor that executes the at least one program stored in the memory. The processor may receive a PDU session generation request message from an access management function (AMF), the PDU session generation request message including high-performance computing capability request information, may select a policy control function (PCF) and at least one user plane function (UPF) based on a PDU session establishment request to perform an association procedure, and may deliver associated PDU session information to a terminal via a base station.

Furthermore, according to an embodiment, the SMF may obtain computing capability information from each of a plurality of UPFs. The SMF may select the at least one UPF with computing capability information of a predetermined level or more among the plurality of UPFs based on the computing capability information received from each of the plurality of UPFs depending on high-performance computing capability request information included in the PDU session generation request message.

Furthermore, according to an embodiment, the high-performance computing capability request information included in the PDU session generation request message may indicate whether a service corresponding to the PDU session generation request message is a service requiring a high-performance computing capability. The high-performance computing capability request information may indicate that the service corresponding to the PDU session generation request message is the service requiring the high-performance computing capability, when the high-performance computing capability request information is a first value. The high-performance computing capability request information may indicate a legacy service, when the high-performance computing capability request information is a second value.

Furthermore, according to an embodiment, the SMF may be connected with a UPF management function and the UPF management function may be connected with the plurality of UPFs to obtain the computing capability information from each of the plurality of UPFs and may determine the at least one UPF for the PDU session generation request message based on the obtained computing capability information. The SMF may obtain information about the at least one UPF determined from the UPF management function.

Furthermore, according to an embodiment, the high-performance computing capability request information included in the PDU session generation request message may indicate whether a service corresponding to the PDU session generation request message is a service requiring a high-performance computing capability. The SMF may deliver the high-performance computing capability request information to the PCF and the PCF may obtain policy information determined via the high-performance computing capability request information to determine the at least one UPF.

According to an embodiment, a method for allocating single network slice selection assistance information (S-NSSAI) may include receiving, by a first network function (NF), a registration request message requesting first type S-NSSAI allocation based on a first service, determining, by the first NF, allowed first type S-NSSAI based on the registration request message, and allocating, by the first NF, the S-NSSAI for the first service based on the allowed first type S-NSSAI.

Furthermore, according to an embodiment, an apparatus for allocating single network slice selection assistance information (S-NSSAI) may include a memory storing at least one program, a transceiver that transmits and receives at least one signal, and a processor that executes the at least one program stored in the memory. The processor may receive a registration request message requesting first type S-NSSAI allocation based on a first service, may determine an allowed first type S-NSSAI based on the registration request message, and may allocate an S-NSSAI for the first service based on the allowed first type S-NSSAI.

Furthermore, according to an embodiment, the first type S-NSSAI may be an S-NSSAI including cloud native metadata. The S-NSSAI including the cloud native metadata may be an S-NSSAI including cloud native system-related information in a network which operates based on a cloud native system.

Furthermore, according to an embodiment, the first NF may deliver a request message including a first type S-NSSAI allocation request to a second NF. The first NF may receive a response message including the allowed first type S-NSSAI determined in the second NF based on the first type S-NSSAI allocation request.

Furthermore, according to an embodiment, the second NF may transmit the first type S-NSSAI allocation request to a third NF connected with cloud orchestration and may obtain at least one allowed first type S-NSSAI in which the cloud native metadata is set by the cloud orchestration. The first NF may obtain the allowed first type S-NSSAI from the second NF.

Furthermore, according to an embodiment, the first type S-NSSAI may be an S-NSSAI for providing a high-performance computing capability based service based on the first service. The S-NSSAI for providing the high-performance computing capability based service may be an S-NSSAI to select at least one network node having a computing capability of a predetermined level or more to provide the first service.

Furthermore, according to an embodiment, the first NF may deliver a request message including a first type S-NSSAI allocation request to a second NF. The first NF may receive a response message including the allowed first type S-NSSAI determined in the second NF based on the first type S-NSSAI allocation request.

Furthermore, according to an embodiment, the second NF may transmit the first type S-NSSAI allocation request to a third NF connected with orchestration and may obtain at least one allowed first type S-NSSAI in which configuration information of the first type S-NSSAI is set by the orchestration. The first NF may obtain the allowed first type S-NSSAI from the second NF.

### BRIEF DESCRIPTION OF THE FIGURES

The above and other objects and features of the present disclosure will become apparent by describing in detail embodiments thereof with reference to the accompanying drawings.

FIG. 1 is a conceptual diagram illustrating a mobile communication system according to an embodiment.

FIG. 2 is a drawing illustrating a device configuration according to an embodiment.

FIG. 3 is a drawing illustrating reference points according to an embodiment.

FIG. 4 is a drawing illustrating a network function and an operation between service controllers according to an embodiment.

FIG. 5 is a drawing illustrating a method for operating based on a service based interface according to an embodiment.

FIG. 6 is a drawing illustrating a service based interface (SBI) based on an SBI structure according to an embodiment.

FIG. 7 is a drawing illustrating a structure in which a base station function is connected with an SBI based on an API according to an embodiment.

FIGS. 8A and 8B are drawings illustrating a method for establishing a PDU session based on a computing capability according to an embodiment.

FIG. 9 is a drawing illustrating a method for establishing a PDU session based on a computing capability according to an embodiment.

FIG. 10 is a drawing illustrating a method for establishing a PDU session based on a computing capability according to an embodiment.

FIG. 11 is a flowchart illustrating a method for establishing a PDU session in an SMF according to an embodiment.

FIG. 12 is a drawing illustrating a method for allocating an S-NSSAI according to an embodiment.

FIG. 13 is a drawing illustrating a structure including a network slice management function according to an embodiment.

FIG. 14 is a drawing illustrating a method for requesting an S-NSSAI including cloud native metadata according to an embodiment.

FIG. 15 is a drawing illustrating a method for requesting an S-NSSAI according to an embodiment.

### DETAILED DESCRIPTION

An embodiment of the present disclosure will be described more fully with reference to the accompanying drawings to such an extent as to be easily embodied by one skilled in the art. However, the present disclosure may be embodied in many different forms and should not be construed as limited to the embodiments set forth herein. In drawings, components or elements not associated with the detailed description may be omitted to describe the present disclosure clearly, and like reference numerals refer to like elements throughout this application.

In the entire specification, a terminal may indicate user equipment (UE), a mobile station (MS), a mobile terminal (MT), an advanced mobile station (AMS), a high reliability mobile station (HR-MS), a subscriber station (SS), a portable subscriber station (PSS), an access terminal (AT), a machine type communication (MTC) device, and the like and may include an entire function or a partial function of the UE, the MS, the MT, the AMS, the HR-MS, the SS, the PSS, the AT, and the like.

Furthermore, a base station (BS) may indicate a node B, an evolved node B (eNB), gNB, an advanced base station (ABS), high reliability base station (HR-BS), an access point (AP), a radio access station (RAS), a base transceiver station (BTS), a mobile multihop relay (MMR)-BS, a relay station (RS) for serving as a base station, a relay node (RN) for serving as a base station, an advanced relay station (ARS) for serving as a base station, a high reliability relay station (HR-RS) for serving as a base station, a small BS [a femto BS, a home node B (HNB), a home eNodeB (HeNB), a pico BS, a macro BS, a micro BS, and the like], and the like and may include an entire function or a partial function of the NB, the eNB, the gNB, the ABS, the AP, the RAS, the BTS, the MMR-BS, the RS, the RN, the ARS, the HR-RS, the small BS, and the like.

In the entire specification, when any portion “includes” any component, unless explicitly described to the contrary, the word “includes” refers to implying the inclusion of stated components but not the exclusion of any other components.

In the specification, each of phrases such as “A or B”, “at least one of A and B”, “at least one of A or B”, “A, B, or C”, “at least one of A, B, and C”, and “at least one of A, B, or C” may include any one or all possible combinations of the items listed together in the corresponding one of the phrases.

The expressions described in the singular in the specification may be interpreted as the singular or plural unless an explicit expression such as “one” or “single” is used.

In the specification, “and/or” includes each of the constituent components and all combinations thereof.

In the specification, the ordinal numbers such as “first” and “second” may be used to describe various components, but do not limit the components. These terms are only used to distinguish one component from another component. For example, without departing from the scope and spirit of the present disclosure, a first component may be referred to as a second component, and similarly, the second component may be referred to as the first component.

In the flowchart described with reference to the drawing in the specification, an operation order may be changed, several operations may be merged or any operation may be segmented, and a specific operation may fail to be performed.

A description will be given of a communication network to which embodiments according to the specification are applied. The communication network may be a 4th generation (4G) communication network (i.e., a long-term evolution (LTE) communication network), a 5th generation (5G) communication network (e.g., a new ratio (NR) communication network), a non-terrestrial network (NTN), or the like. In the entire specification, a network may include, for example, a wireless Internet, such as wireless fidelity (WiFi), a portable Internet, such as wireless broadband Internet (WiBro) or world interoperability for microwave access (WiMax), a 2nd generation (2G) mobile communication network, such as global system for mobile communication (GSM) or code division multiple access (CDMA), a 3rd generation (3G) mobile communication network, such as wideband code division multiple access (WCDMA) or CDMA2000, a 3.5th generation (3.5G) mobile communication network, such as high speed downlink packet access (HSDPA) or high speed uplink packet access (HSUPA), a 4th generation (4G) mobile communication network, such as a long term evolution (LTE) network or an LTE-Advanced network, a 5th generation (5G) mobile communication network, and the like.

In the entire specification, a terminal may be referred to as an access terminal, a mobile terminal, a station, a subscriber station, a mobile station, a portable subscriber station, a node, a device, or the like.

Herein, a communicable desktop computer, a laptop computer, a tablet PC, a wireless phone, a mobile phone, a smart phone, a smart watch, a smart glass, an e-book reader, a portable multimedia player (PMP), a portable game console, a navigation device, a digital camera, a digital multimedia broadcasting (DMB) player, a digital audio recorder, a digital audio player, a digital picture recorder, a digital picture player, a digital video recorder, a digital video player, or the like may be used as the terminal.

In the entire specification, a base station may be referred to as NodeB, evolved NodeB, a base transceiver station (BTS), a radio base station, a radio transceiver, an access point, an access node, a road side unit (RSU), a digital unit (DU), a cloud digital unit (CDU), a radio remote head (RRH), a radio unit (RU), a transmission point (TP), a transmission and reception point (TRP), a relay node, or the like.

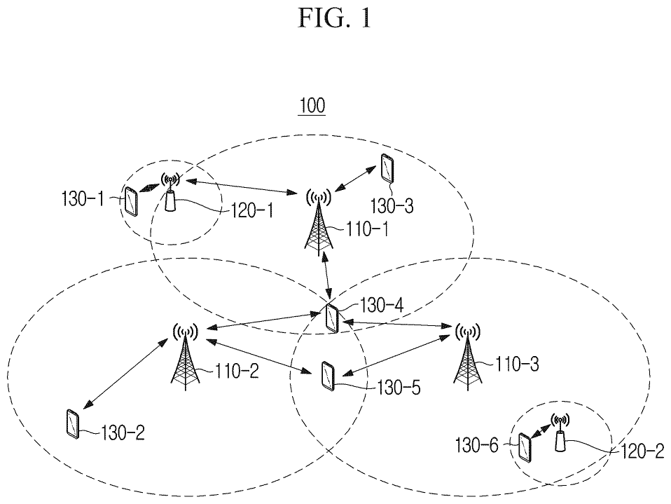

FIG. 1 is a conceptual diagram illustrating a mobile communication system according to an embodiment.

Referring to FIG. 1, a communication system 100 may include a plurality of communication nodes 110-1, 110-2, 110-3, 120-1, 120-2, 130-1, 130-2, 130-3, 130-4, 130-5, and 130-6. The plurality of communication nodes may support 4G communication (e.g., long term evolution (LTE) or LTE-advanced (LTE-A)), 5G communication (e.g., new radio (NR)), or the like defined in the 3rd generation partnership project (3GPP) standard. The 4G communication may be performed in a frequency band of 6 GHz or less and the 5G communication may be performed in a frequency band of 6 GHz or more as well as a frequency band of 6 GHz or less.

For example, for the 4G and 5G communications, the plurality of communication nodes may support a code division multiple access (CDMA) based communication protocol, a wideband CDMA (WCDMA) based communication protocol, a time division multiple access (TDMA) based communication protocol, a frequency division multiple access (FDMA) based communication protocol, an orthogonal frequency division multiplexing (OFDM) based communication protocol, a filtered OFDM based communication protocol, a cyclic prefix OFDM (CP-OFDM) based communication protocol, a discrete Fourier transform-spread-OFDM (DFT-s-OFDM) based communication protocol, an orthogonal frequency division multiple access (OFDMA) based communication protocol, a single carrier FDMA (SC-FDMA) based communication protocol, a non-orthogonal multiple access (NOMA) based communication protocol, a generalized frequency division multiplexing (GFDM) based communication protocol, a filter bank multi-carrier (FBMC) based communication protocol, a universal filtered multi-carrier (UFMC) based communication protocol, a space division multiple access (SDMA) based communication protocol, or the like.

Furthermore, the communication system 100 may further include a core network. When the communication system 100 supports the 4G communication, the core network may include a serving-gateway (S-GW), a packet data network (PDN)-gateway (P-GW), a mobility management entity (MME), or the like. When the communication system 100 supports the 5G communication, the core network may include a user plane function (UPF), a session management function (SMF), an access and mobility management function (AMF), or the like.

Meanwhile, each of the plurality of communication nodes 110-1, 110-2, 110-3, 120-1, 120-2, 130-1, 130-2, 130-3, 130-4, 130-5, and 130-6 (or network functions) constituting the communication system 100 may have the following structure.

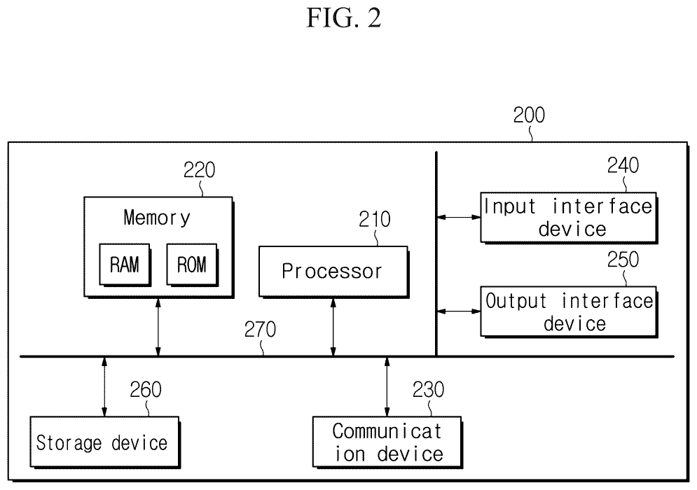

FIG. 2 is a drawing illustrating a device configuration according to an embodiment. Referring to FIG. 2, a communication node 200 (a network function) may include at least one processor 210, a memory 220, and a transceiver 230 connected with a network to perform communication. Furthermore, the communication node 200 may further include an input interface device 240, an output interface device 250, a storage device 260, and the like. The respective components included in the communication node 200 may be connected with each other by a bus 720 to communicate with each other.

However, the respective components included in the communication node 200 may be connected with each other via an individual interface or an individual bus around the processor 210, rather than the common bus 270. For example, the processor 210 may be connected with at least one of the memory 220, the transceiver 230, the input interface device 240, the output interface device 250, and the storage device 260 via a dedicated interface.

The processor 210 may execute a program command stored in at least one of the memory 220 and the storage device 260. The processor 210 may refer to a central processing unit (CPU), a graphics processing unit (GPU), or a dedicated processor in which methods according to embodiments of the present disclosure are performed. Each of the memory 220 and the storage device 260 may be composed of at least one of a volatile storage medium and a non-volatile storage medium. For example, the memory 220 may be composed of at least one of a read only memory (ROM) and a random access memory (RAM).

Referring again to FIG. 1, the communication system 100 may include the plurality of base stations 110-1, 110-2, 110-3, 120-1, and 120-2 and the plurality of terminals 130-1, 130-2, 130-3, 130-4, 130-5, and 130-6. The communication system 100 including the base stations 110-1, 110-2, 110-3, 120-1, and 120-2 and the terminals 130-1, 130-2, 130-3, 130-4, 130-5, and 130-6 may be referred to as an “access network”. Each of the first base station 110-1, the second base station 110-2, and the third base station 110-3 may form a macro cell. Each of the fourth base station 120-1 and the fifth base station 120-2 may form a small cell. The fourth base station 120-1, the third terminal 130-3, and the fourth terminal 130-4 may be within cell coverage of the first base station 110-1. The second terminal 130-2, the fourth terminal 130-4, and the fifth terminal 130-5 may be within cell coverage of the second base station 110-2. The fifth base station 120-2, the fourth terminal 130-4, the fifth terminal 130-5, and the sixth terminal 130-6 may be within cell coverage of the third base station 110-3. The first terminal 130-1 may be within cell coverage of the fourth base station 120-1. The sixth terminal 130-6 may be within cell coverage of the fifth base station 120-2.

Herein, each of the plurality of base stations 110-1, 110-2, 110-3, 120-1, and 120-2 may be referred to as NodeB, evolved NodeB, gNB, xNB, a base transceiver station (BTS), a radio base station, a radio transceiver, an access point, an access node, or the like. Each of the plurality of terminals 130-1, 130-2, 130-3, 130-4, 130-5, and 130-6 may be referred to as user equipment (UE), a terminal, an access terminal, a mobile terminal, a station, a subscriber station, a mobile station, a portable subscriber station, a node, a device, or the like.

Meanwhile, each of the plurality of base stations 110-1, 110-2, 110-3, 120-1, and 120-2 may operate in a different frequency band or may operate in the same frequency band. The plurality of base stations 110-1, 110-2, 110-3, 120-1, and 120-2 may be connected with each other via an ideal backhaul link or a non-ideal backhaul link and may exchange information with each other via the ideal backhaul link or the non-ideal backhaul link. Each of the plurality of base stations 110-1, 110-2, 110-3, 120-1, and 120-2 may be connected with the core network via the ideal backhaul link or the non-ideal backhaul link. Each of the plurality of base stations 110-1, 110-2, 110-3, 120-1, and 120-2 may transmit the signal received from the core network to the corresponding terminals 130-1, 130-2, 130-3, 130-4, 130-5, and 130-6 and may transmit the signal received from the corresponding terminals 130-1, 130-2, 130-3, 130-4, 130-5, and 130-6 to the core network.

As an example, the 5G system may be composed of an architecture based on an interaction between network functions (NFs). As an example, the core network of the 5G system, 5GC, may include various entities. In detail, an access and mobility management function (AMF) may manage access and mobility of the terminal. Furthermore, the AMF may perform a function for managing non-access stratum (NAS) security. Furthermore, the AMF may perform a function for handling mobility of the terminal which is in an idle state.

Furthermore, a session management function (SMF) may manage a session. As an example, the SMF may perform a function for allocating a terminal Internet protocol (IP) address and may control a protocol data unit (PDU) session.

Furthermore, a policy control function (PCF) may perform a function for controlling a policy. Furthermore, a user plane function (UPF) for performing a function for controlling a user plane may be included. The UPF may be a function of a gateway for transmitting and receiving data, which may perform all or some of user plane functions of a serving gateway (S-GW) and a packet data network gateway (P-GW) of the previous mobile communication system (4G). Furthermore, the UPF may perform a function for handling the PDU. Furthermore, an application function (AP) for controlling an application function may be included. The AF may be a function for providing the terminal with a plurality of services. Furthermore, unified data management (UDM) for managing unified data may be included. Herein, the UDM may perform a function for managing subscriber information.

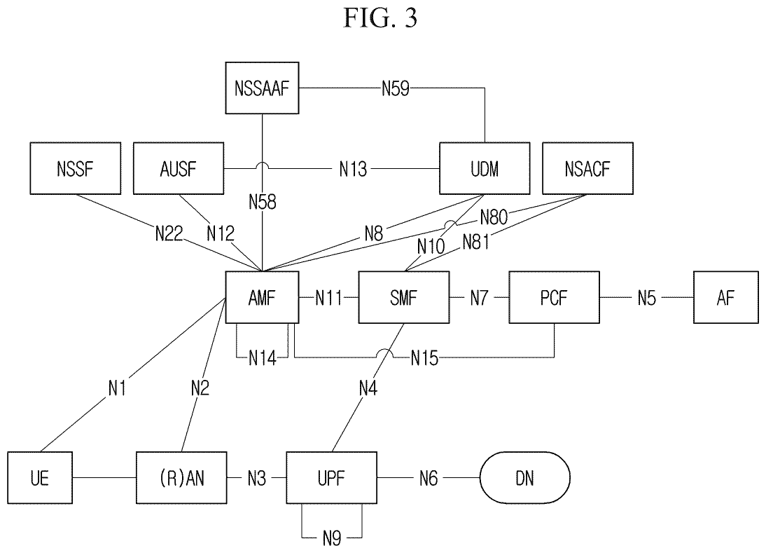

FIG. 3 is a drawing illustrating reference points according to an embodiment of the present disclosure. Referring to FIG. 3, the reference point may indicate an interaction between network function (NF) services in NFs described by the point-to-point reference point between two NFs. As an example, N1 may be a reference point between a UE and an access management function (AMF). N2 may be a reference point between the (R)AN and the AMF. N3 may be a reference point between the (R)AN and the user plane function (UPF). The other reference points are the same as, but not limited to, Table 1 below.

TABLE 1
N1: Reference point between the UE and the AMF.
N2: Reference point between the (R)AN and the AMF.
N3: Reference point between the (R)AN and the UPF.
N4: Reference point between the SMF and the UPF.
N5: Reference point between the PCF and an AF or TSN AF.
N6: Reference point between the UPF and a Data Network.
N7: Reference point between the SMF and the PCF.
N8: Reference point between the UDM and the AMF.
N9: Reference point between two UPFs.
N10: Reference point between the UDM and the SMF.
N11: Reference point between the AMF and the SMF.
N12: Reference point between AMF and AUSF.
N13: Reference point between the UDM and Authentication Server
function the AUSF.
N14: Reference point between two AMFs.
N15: Reference point between the PCF and the AMF in the case of non-
roaming scenario, PCF in the visited network and AMF in the case of
roaming scenario.
N16: Reference point between two SMFs, (in roaming case between SMF
in the visited network and the SMF in the home network).
N16a: Reference point between SMF and I-SMF.
N17: Reference point between AMF and 5G-EIR.
N18: Reference point between any NF and UDSF.
N19: Reference point between two PSA UPFs for 5G LAN-type service.
N22: Reference point between AMF and NSSF.

The 5G mobile core of FIGS. 1 to 3 described above is designed in a single structure, but there is a need to design a core network with a service based architecture after 5G (e.g., 6G). As an example, the network may be composed of a network function which is a software component which operates based on interaction and as a result, may have horizontal expandability and flexibility for satisfying various detailed requirements. Furthermore, the mobile core network may operate based on a maturing cloud-native technology in which the network functions are arranged in a plurality of distributed clouds. Herein, because the current 5G mobile core structure has a limitation in supporting a cloud-native technology, there may be a need to change a paradigm. Considering the above points, the core network may be designed as a service based architecture (SBA) based network. The SBA based core network may be a software component with various functions, which may be decomposed and included into a network function (NF). Herein, the NF may expose a service in the form of a restful application programming interface (API). In other words, when the network is decomposed into the NF which is the software component, it may be able to be arranged to be flexible and expandable and as a result, may have a service based structure. Furthermore, as an example, the NF in the SBA based core network may be containerized to be disposed on the plurality of clouds, may share resources via a cloud technology, and is able to dynamically perform allocation for a service operation. A flexible and expandable core network may be constructed via those described above. As a result, it may be possible to provide various services.

As an example, it is expected that various types of services will emerge after 5G. Considering the above-mentioned service, the core network needs to be designed based on the SBA. Hereinafter, considering the above points, a description will be given of an operation method in the SBA based core network. Based on the current 5G core network, a signal procedure for the terminal may be in a form in which some steps of the procedure are processed to operate in each NF based on an NF chain. Respective NFs may be connected with each other by the same interface as Table 1 above. In other words, the NFs may constitute a static connection relationship between the NFs. However, there is a need to be automatically searched with regard to an NF search and selection operation in a large-scale dynamic structure. As an example, there may be a network repository function (NRF) in the current 5G core network. The NF may be registered with the NRF. The NF may transmit a query to the NRF to request a service and may select another NF in response to it. Herein, as an example, it is difficult to include service search and selection logic in each of the NFs. Considering the above points, a service communication proxy (SCP) may be used. Because the SCP is able to perform service search and selection of the NF instead of the NF, it may relieve the burden in which the NF directly performs the service search and selection. However, even when the service search and selection is performed by the SCP, there is a need to register NFs in the NRF and searching for the NFs. In other words, the service search and selection may be performed in a centralized manner based on the NRF. As an example, because the centralized service search and selection is able to cause a bottleneck phenomenon of control plane traffic and latency is able to occur due to a plurality of signal search procedures, there may be a limitation.

Herein, the above-mentioned SBA based core network may be required in a new form in an environment in which a service type varies and the number of service types increases after 5G. The SBA based core network may perform a corresponding function without the above-mentioned NRF and SCP. As an example, when operating based on the SBA based core network, a role of selecting an appropriate instance of a target service in an application program context may be performed by a service agent and a service controller and common logic for NF search and selection may be included in the service agent. In other words, all network functions may be connected with a service agent with a proxy role of performing a service request and response instead and the service agent may perform all service registration/search and selection in signal logic of the network function.

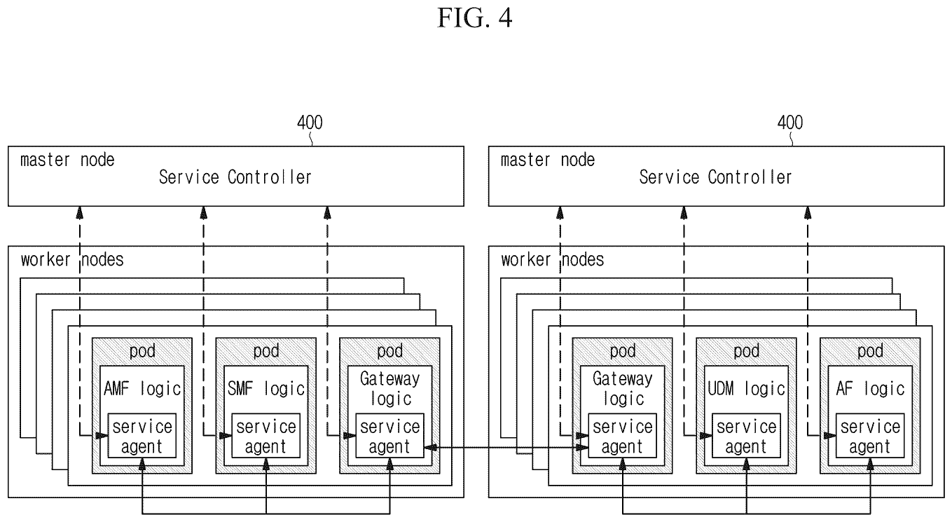

As an example, FIG. 4 is a drawing illustrating a service controller and a service agent according to an embodiment. Referring to FIG. 4, a service controller 400 may control a service agent in an individual NF. Each of service agents in the individual NF may have a proxy role of performing a service request and response instead via a mutual connection.

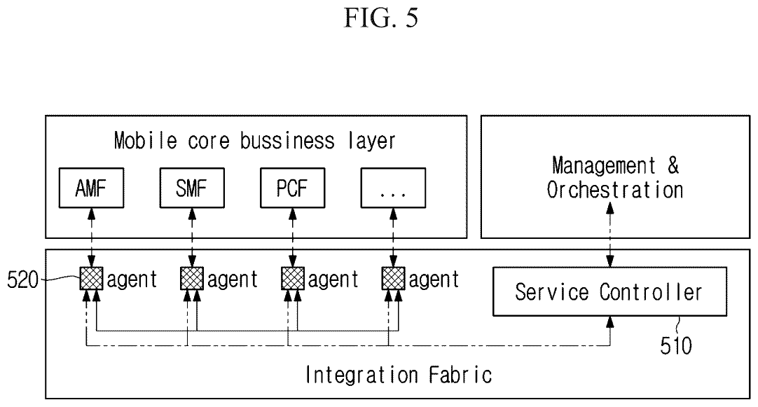

As a more detailed example, referring to FIG. 5, a control plane in the 5G core network in a service based architecture (SBA) may include a plurality of network functions NFs. Each network function may perform a predetermined function. As an example, the control plane may be composed of a middleware layer of an integration fabric to reduce complexity. The integration fabric may be composed of a service controller 510 and an agent 520. Each network function may be performed by directly using the agent 520 in an execution file for service routing. On the other hand, the service controller 510 may serve as service registry, which may collect information about each position and a runtime environment parameter of the agent 520. Furthermore, the service controller 510 may define and configure a routing function of the agent via an interaction with a management and orchestration layer. As an example, the integration fabric may provide an integrated programming application programming interface (API) via the agent 520 to facilitate a smooth interaction with a business layer composed of a core network function.

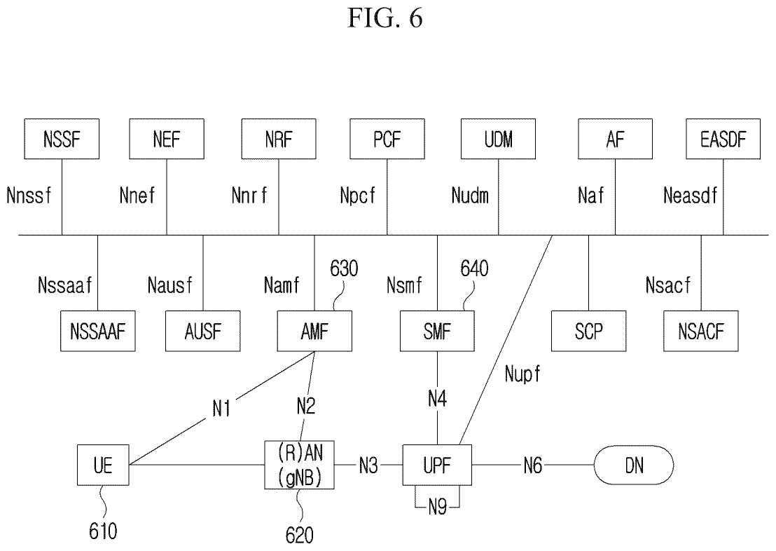

FIG. 6 is a drawing illustrating a service based interface (SBI) based on an SBI structure according to an embodiment. Referring to FIG. 6, all network functions may be an SBA, which may be configured in the service based interface (SBI). As an example, a specific NF may provide another authorized NF with a service and may perform an interaction via an API of a client-server. In other words, an existing communication signal message may be replaced with an API call of a shared service bus. Modularity, expandability, stability, and cost-effectiveness may be more improved than an existing communication system. As an example, a main change of the SBA may be switching into a consumer-producer communication paradigm in a point-to-point protocol. In other words, conventionally, because a consumer and a producer should directly establish a communication channel using the point-to-point protocol, as prior knowledge for mutual presence and identifiers is able to be required, there was a limitation in expansion. On the other hand, in the SBA, a service consumer in a consumer-, producer-, or client-server model may search for an available appropriate network service to obtain connection information, via a service search and registration mechanism. As an example, the above-mentioned operation may be implemented by, but not limited to, the NRF of the 5G core network.

Referring to FIG. 6, the NF may provide a message associated with a communication signal to another NF or may receive the message, via a restful application programming interface (API). In FIG. 6, a UE 610 may exchange a message with a base station 620. The above-mentioned N1 interface may be formed between the UE 610 and an AMF 630 and an N2 interface may be formed between the base station 620 and the AMF 630. As an example, a separate interface may fail to be formed between the base station 620 and an SMF 640 in the SBI based structure of FIG. 6 and the core network structure of FIG. 3.

Thus, when trying to establish a PDU session in a network, a session establishment request delivered from the UE 610 to the base station 620 may be delivered to the AMF 630. A message necessary for session establishment may be delivered to another NF via an interface with which the AMF 630 is connected and the SBI based API.

As an example, the AMF 630 may select the SMF 640 based on a PDU session establishment request obtained from the UE 610 and may deliver information necessary for PDU session establishment to the SMF 640. The AMF 630 may deliver a PDU session-SM context generation request to the SMF 640 based on the PDU session establishment request and may obtain a PDU session-SM context generation response in response to it. The SMF 640 may obtain PDU session establishment-related information from the AMF 630 and may perform a PCF selection procedure. A description will be given below of it.

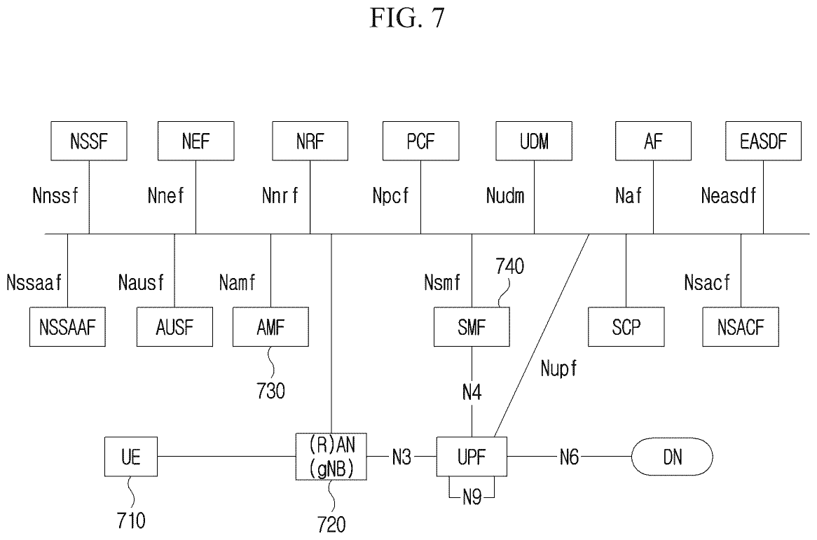

FIG. 7 is a drawing illustrating a structure in which a base station function is connected with an SBI based on an API according to an embodiment.

Referring to FIG. 7, a base station may be implemented with a software component and may have a structure in which it is connected with the SBI to be the same as another NF. In detail, a base station 720 may replace a communication-related message with an API call of a shared service bus via a restful API and as a result, may provide another NF with a service or may receive the service. In other words, the base station 720 may be implemented as a function using a software component like another NF. Furthermore, the base station 720 may be containerized based on the software component to be disposed on a plurality of clouds and may be able to share resources via a cloud technology and dynamically allocate a service operation, but not limited thereto. Modularity, expandability, stability, and cost-effectiveness may be more improved than an existing communication system via those described above, but not limited thereto. Herein, an interface in an API based SBI of the base station 720 may be referred to as “Nran”. However, this is merely one example, is not limited to the name, and may be referred to as another name. Hereinafter, for convenience of description, it is referred to as “Nran”.

As an example, in an existing wireless communication system, as the base station 720 delivers a non-access stratum (NAS) message to the AMF 730 based on the session establishment request obtained from a UE 710 and the AMF 730 exchanges a communication-related message in the core network, session establishment may be performed. This is as described above.

However, in a new wireless communication system, the base station 720 may provide a service from the SBI to another NF or may receive the service, via an API to be similar to the NF. In other words, the base station 720 may perform direct communication-related message exchanging with other NFs without passing through the AMF 730 via the SBI. As a detailed example, the base station 720 may exchange a message associated with session establishment via direction communication with the SMF 740 without passing through the AMF 730. There is a need to define a communication-related message between the base station 720 and the SMF 740 in the above-mentioned situation. A description will be given below of a method for performing session establishment with regard to the above-mentioned points.

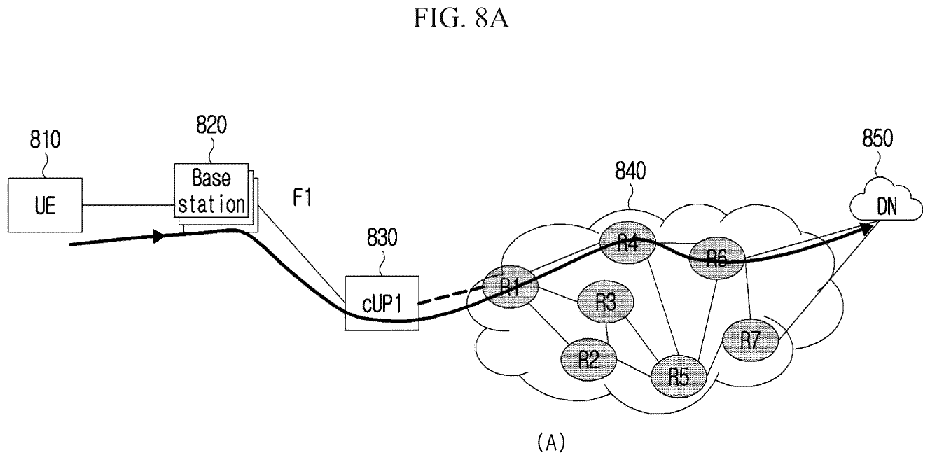

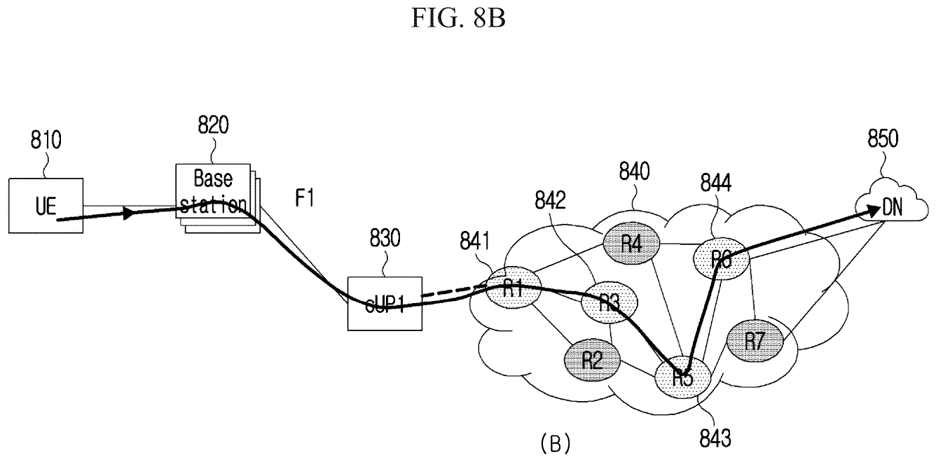

FIGS. 8A and 8B are drawings illustrating a method for establishing a PDU session based on a computing capability according to an embodiment.

Referring to FIG. 8A, a terminal 810 may access a base station 820 via initial connection establishment, may be registered with a core network, and may configure a data transfer path to receive a service provided from a data network (DN) 850. The terminal 810 may perform a radio resource control (RRC) connection establishment procedure with the base station 820 and may perform a connection to a control plane via RRC. Furthermore, the terminal 810 may perform an initial registration procedure to be connected with the core network and may be connected with the core network via an AMF. The AMF may select an SMF based on the service provided to the terminal 810. The selected SMF may determine a data transfer-related policy, may select at least one UPF to perform transmission, may configure a data transfer path, and may provide the service. Referring to FIG. 8A, conventionally, the data transfer path may be determined via the at least one UPF selected by the SMF and the service may be provided to the terminal 810 via the path.

As an example, conventionally, only whether it is possible to perform a service connection was checked to configure a data transfer path, without regard to a computing capability and a computing resource in conjunction with the service connection, the service was provided via the configured path. However, there is a need to consider a computing capability and a computing resource in conjunction with providing the service. The computing capability may refer to a speed and an amount of a data processing task of each node in a network environment and the entire network system or a network. Compute capabilities and data processing capabilities may be different from each other for each node in the network. Thus, a computing capability for each node in the network may be differently determined. As an example, the computing capability may be a processing capability, which may be a central processing unit (CPU) and graphic processing unit (GPU) based processing capability. The CPU may be a processing unit for processing each piece of data in a node and the GPU may be a processing unit for supporting parallel computation to have better performance. As another example, a processing unit with high performance may be considered with regard to a neural network of artificial intelligence (AI) and is not limited to a specific form. In other words, the computing capability may be a hardware configuration in a network node, which may vary depending on the processing unit. Furthermore, the computing capability may consider a random access memory (RAM) and a cache as memories, which may be associated with efficiency of a data processing task occurring in the node. As an example, a computing capability of a node with excellent memory performance may be higher than another network node. Furthermore, the computing capability may consider storage as a data storage device and may consider a data read/write technology and a network interface as a capability to read and write data. In other words, each node in the network or the entire network system may have a different computing capability via the above-mentioned configurations associated with the computing capability.

Processable data may vary depending on a computing capability which varies for each node in the network. Conventionally, when a data path in which the terminal is registered with the core network to receive the service is determined, a node may be determined with regard to only a connection for providing the service, without regard to a computing capability of each node or a computing capability of the network system, and the data transfer path may be established.

A service provided by a new wireless communication system (e.g., 6G) may include services which requires a high computing capability. There is a need to consider a computing capability even in the network with regard to it. As a detailed example, referring to FIG. 8B, respective nodes in the network may have different computing capabilities. As an example, specific nodes among the nodes in the network may be composed of the same CPU or GPU as a network of an existing wireless communication system. On the other hand, specific nodes 841, 842, 843, and 844 may have a high computing capability based on high-performance data processing. As an example, there may be nodes with hardware dedicated to AI processing or the other high-performance data processing units in the network node. Herein, when the terminal requests a service requiring a high computing capability, a data transfer path for providing the service may be provided via the nodes 841, 842, 843, and 844, each of which has the high computing capability. In other words, nodes, each of which has the high computing capability, among the nodes in the network may be selected to smoothly provide services, each of which requires the high computing capability, as new services.

As an example, services for processing and providing vast amounts of data at a high speed like generative AI may be applied to an AI based service in the new wireless communication system (e.g., 6G). Furthermore, the terminal may request the service requiring the high computing capability, such as a case in which learning for vast amount of data is performed with regard to the neural network of AI. However, it is not limited thereto and another type of service may be provided. Herein, when the service is provided via a data path which is registered and established with the core network to provide the service of the terminal and when a computing capability for the service is not met in each of network nodes and the network system, it may be impossible to smoothly provide the service. Furthermore, when the network also establishes a data transfer path and provides the service, without regard to the computing capability, because an overload for the computing capability is able to occur in a specific node, there may occur a problem in which another service except for the service is not smoothly provided. Considering the above points, there may be a need for a method for selecting a node with regard to a computing capability required for the provided service and managing a PDU session. A description will be given below of it.

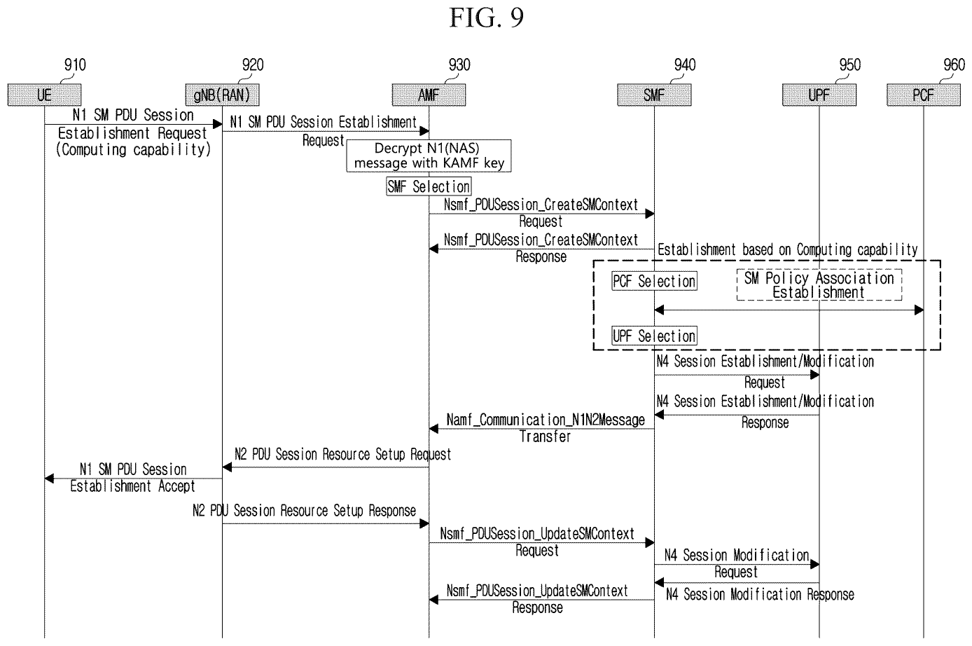

FIG. 9 is a drawing illustrating a method for establishing a PDU session based on a computing capability according to an embodiment. Referring to FIG. 9, the PDU session may be established in a network. Herein, a RAN 920 (or a base station) may have, but is not limited to, a structure for providing a service to other NFs or receiving the service, via an API in an SBI based on FIG. 7 described above.

When establishing the PDU session, a terminal 910 may transmit a PDU session establishment request for providing the service to an AMF 930 via the base station 920. As an example, the PDU session establishment request may include information about at least any one of a PDU session identifier, a request type (an initial request, handover, or an emergency situation), network slice information (single-network slice selection assistance information (S-NSSAI)), data network name (DNN) information, quality of service (QoS)-related information, PDU session type information (IPv4, IPv6, etc.), session management information, encryption/integrity information, additional information, and position information, but not limited to the embodiment, and may further include another piece of information.

Computing capability-related information may be further included in the PDU session establishment request message. There is a need to provide a service requiring a high computing capability as a specific service as described above in a new wireless communication system (e.g., 6G) and there is a need to establish a network system and a network node suitable for the service. Thus, computing capability-related information (or a computing capability-related parameter) may be included in the PDU session establishment request message.

As an example, the computing capability-related information may be information indicating that a high computing capability and a high computing resource are required. As a detailed example, when the parameter is set to a first value as the computing capability-related information, a network node with the high computing capability may be selected in conjunction with the established PDU session. In other words, the parameter may be information indicating that the high computing capability is required. On the other hand, when the parameter is set to a second value as the computing capability-related information, the network node may be selected on the basis of whether it is possible to perform a service connection such that the established PDU session is the same as before. As a detailed example, a case in which the high computing capability is required may be considered as a case in which the terminal requests a generative AI based service and PDU session establishment is required. Herein, the above-mentioned first value may be included in the PDU session establishment request and thus, a network node considering the high computing capability may be selected.

As another example, the computing capability-related information may be information indicating that the high computing capability and the high computing resource are required. As a detailed example, when the parameter is set to the first value as the computing capability-related information, a network node with the high computing capability may be selected in conjunction with the established PDU session. On the other hand, when the parameter is set to the second value as the computing capability-related information, the network node may be selected on the basis of whether it is possible to perform a service connection such that the established PDU session is the same as before. This is as described above.

As a detailed example, when the parameter is set to a third value as the computing capability-related information, the established PDU session may be a case in which a very low computing capability is required. Alternatively, when the parameter is set to the third value as the computing capability-related information, the service may fail to be processed in a data network and it may be indicated that data processing is required in an edge node in the network. As an example, when service processing for Internet of things (IoT) based sensor data is performed, it may be indicated that a very low computing capability is required or it may be indicated that data processing is required in the edge node, but not limited to the embodiment.

As another example, detailed parameters associated with the computing capability may be included in the PDU session establishment request message. As a detailed example, at least any one of priority information associated with the computing capability, ensured computing capability information, latency time-related information, packet error-related information, and the other information may be included. As an example, the priority information associated with the computing capability may indicate a priority based on the computing capability. In other words, an establishment request with a high priority may be first allocated to a network node and system with a high computing capability to be processed.

Furthermore, minimum computing capability information which should be ensured may indicate a minimum computing capability necessary in conjunction with the service. As an example, the information may be set to a low value in conjunction with an existing service and the information may be set to a high value for a service requiring the high computing capability as a new service. Furthermore, at least any one of latency time-related information considering the computing capability and packet error-related information considering the computing capability may be further included, but not limited thereto.

As another example, the computing capability information may be information included in QoS-related information in conjunction with the PDU session establishment request message. The QoS-related information may include information about at least any one of a bandwidth, latency, a packet loss rate, and reliability. Herein, computing capabilities information may be further included as QoS-related information. As an example, as described above, the computing capabilities information may be included as the QoS-related information with regard to a service requiring the high computing capability as a service (e.g., generative AI) requiring the high computing capability or the high computing resource. As an example, when traffic for the generative AI service request is generated in the terminal, there is a need to be processed via networks, each of which has the high computing capability and the high computing resource, and a parameter or a setting value therefor may be applied to the QoS-related information.

Furthermore, as an example, conventionally, enhanced mobile broadband (eMBB), ultra-reliable low-latency communication (URLLC), and massive machine type communication (mMTC) may be considered as a service provided in conjunction with PDU session establishment. Herein, a service considering the high computing capability may be further considered in conjunction with PDU session establishment and may not be limited to a specific name. In other words, provision of a service in which the high computing capability should be ensured as a specific service may be considered. Furthermore, a network slice may also be established based on those described above. As an example, conventionally, an eMBB slice for ensuring a high bandwidth, a URLLC slice for ensuring ultra-reliable low latency and high reliability, and an mMTC slice for supporting massive connection density may be considered. Herein, a high computing capability slice for ensuring high computing capability support may be further considered. In other words, a slice considering the high computing capability may be established as a specific network slice. The slice name may not be limited to a specific name.

As another example, an identifier indicating a service requiring the high computing capability may be added to a QoS Identifier (e.g., a 5G QoS Identifier). An identifier for a service indicating that the high computing capability is required as the same service as generative AI may be added to the QoS Identifier. As a result, a service requiring the high computing capability may be indicated. In other words, a computing capability-related setting may be added in conjunction with QoS.

As an example, when the computing capability-related setting is performed as one of QoS-related parameters, a setting value for an allowed computing capability may be determined. Herein, the setting value for the allowed computing capability may be, but is not limited to, a setting value based on the same processing performance as a CPU or a GPU. As a detailed example, a setting value for the computing capability may be set to be high in a service of the same type as the generative AI. As another example, it may be possible to set a priority for the service requiring the high computing capability and is not limited to a specific form.

Referring to FIG. 9, the AMF 930 may select an SMF 940 based on the PDU session establishment request message transmitted from the terminal via the base station 920 and may deliver a PDU session generation request to the selected SMF 940. The SMF 940 may select a policy control function (PCF) 960 and at least one user plane function (UPF) 950 for PDU session establishment based on the PDU session generation request received from the AMF 930. In other words, the SMF 940 may determine a policy and at least one UPF associated with a PDU session. Herein, as described above, the SMF 940 may receive computing capability-related information (or a computing capability-related parameter) from the AMF 930 and may perform PDU session establishment with regard to a computing capability.

As an example, the SMF 940 may determine a policy for the computing capability. In other words, the computing capability policy may be separately established. The SMF 940 may identify a user, may identify a service, may verify a computing capability requirement according to the service to determine a policy for a computing capability, and may reflect it to select the UPF 950.

As another example, the policy for the computing capability may be established within a QoS policy. In other words, when determining a policy for PDU session establishment, the SMF 940 may further reflect computing capability information (or a computing capability-related parameter) and may determine a policy based on it.

As another example, even when the SMF 940 verifies a slice, it may also consider a case in which it verifies a computing capability as described above, but may not be limited to a specific form.

As another example, a session requiring a computing capability guarantee and a session not requiring the computing capability guarantee may be classified. As an example, the SMF 940 may determine whether there is a PDU session requiring the computing capability guarantee via the computing capability-related information (or the computing capability-related parameter) obtained from the AMF 930 and may select a resource and the UPF 950 based on it. In other words, the SMF 940 may differentiate the PDU session on the basis of whether the guarantee is required in conjunction with the computing capability.

Next, the case in which the SMF 940 selects the at least one UPF 950 may be considered. As an example, the UPF 950 may have a different computing capability. As an example, a specific UPF may have a high computing capability via a high-performance processing unit. Another specific UPF may have a lower computing capability than a node in the form of a legacy. Herein, the SMF 940 may manage computer capability information for each of the at least one UPF 950 via an interface (e.g., an N4 interface) with the UPF 950. As an example, information indicating a computing capability of each UPF may be included in a protocol used in the interface with the UPF 950 in the SMF 940. As a detailed example, a UPF capable of ensuring the computing capability as the high-performance computing capability may indicate a first value and a UPF incapable of ensuring the computing capability may indicate a second value. As another example, when the computing capability is degraded as the computing capability is degraded by data processing in the UPF, even the UPF with a high-performance function may indicate the second value incapable of ensuring the computing capability, but not limited thereto. As an example, the SMF 940 may verify current computing capability information of the UPF 950 depending a data processing status and may select the at least one UPF 950 based on it.

When processing traffic with regard to the computing capability requirement of the UPF 950 and establishing a routing path, the SMF 940 may deliver a rule for a high computing capability requirement in the same level as QoS or as information included in the QoS, such that routing is performed based on it. In other words, the computing capability-related information may also be included in rule information delivered by the SMF 940.

As another example, the computing capability may be mapped to the same level as the QoS in a process of establishing a bearer mapped to the QoS. As an example, QoS flow, the computing capability, and the bearer may be established to be mapped one to one.

As another example, the computing capability information may be included with the QoS to be reflected in bearer mapping and is not limited to a specific form. As a detailed example, when a mobile phone proceeds with a service requesting to edit a generative AI based video, a high computing capability and a high computing resource may be required. When the service is requested, a parameter indicating it may be included in the PDU session establishment request and the parameter may be delivered to a network. The SMF 940 may select the UPF 950 with regard to the parameter information in the process of establishing the PDU session. This is as described above.

As another example, the computing capability information may be added to QoS-related information. As an example, a resource availability setting capable of rejecting or limiting a session request depending on a QoS requirement, when there is a lack of network resources, a priority setting of assigning a high priority to emergency communication or an important service, a slice setting of continuously verifying a QoS function of a network slice and suitability of session establishment, and a QoS management setting of performing continuous monitoring and update to maintain QoS while a PDU session is activated may be consider in the QoS. Herein, computing capability linkage information may be considered as a QoS-related setting. In other words, PDU session establishment may be performed in conjunction with computing capability information in the network and monitoring and update for whether the computer capability is ensured may be performed in conjunction with the PDU session establishment.

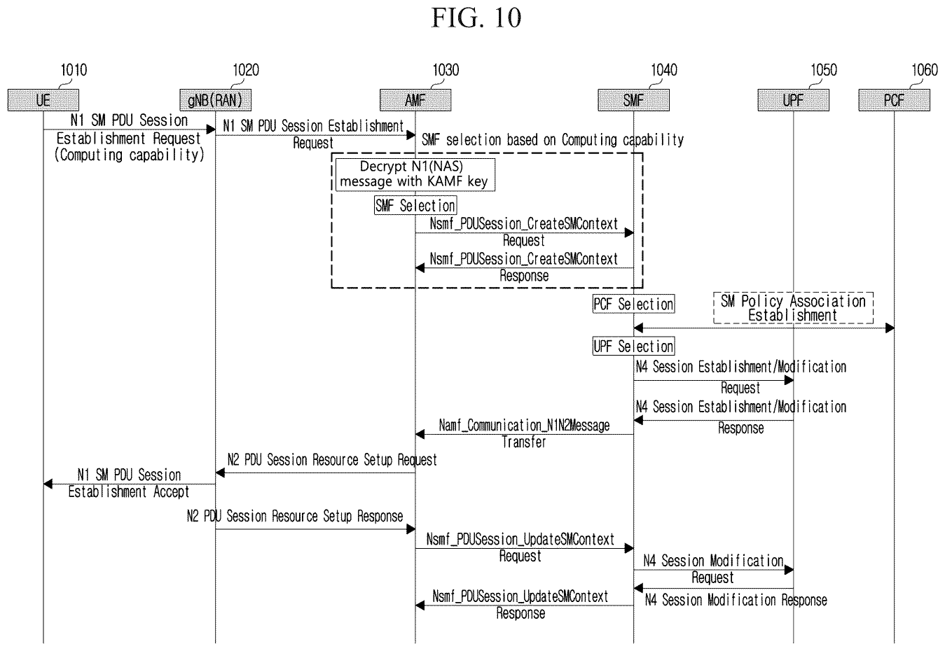

FIG. 10 is a drawing illustrating a method for establishing a PDU session based on a computing capability according to an embodiment.

Referring to FIG. 10, the PDU session may be established in a network. Herein, a RAN 1020 (or a base station) may have, but is not limited to, a structure for providing a service to other NFs or receiving the service, via an API in an SBI based on FIG. 7 described above.

When establishing the PDU session, a terminal 1010 may transmit a PDU session establishment request for providing the service to an AMF 1030 via the base station 1020. As an example, the PDU session establishment request may include information about at least any one of a PDU session identifier, a request type (an initial request, handover, an emergency situation), network slice information (single-network slice selection assistance information (S-NSSAI)), data network name (DNN) information, quality of service (QoS)-related information, PDU session type information (IPv4, IPv6, etc.), session management information, encryption/integrity information, additional information, and position information, but not limited to the embodiment, and may further include another piece of information.

Computing capability-related information may be further included in the PDU session establishment request message. There is a need to provide a service requiring a high computing capability as a specific service as described above in a new wireless communication system (e.g., 6G) and there is a need to establish a network system and a network node suitable for the service. Thus, computing capability-related information (or a computing capability-related parameter) may be included in the PDU session establishment request message.

As an example, the computing capability-related information may be information indicating that a high computing capability and a high computing resource are required. As a detailed example, when the parameter is set to the first value as the computing capability-related information, a network node with the high computing capability may be selected in conjunction with the established PDU session. In other words, the parameter may be information indicating that the high computing capability is required. On the other hand, when the parameter is set to a second value as the computing capability-related information, the network node may be selected on the basis of whether it is possible to perform a service connection such that the established PDU session is the same as before. As a detailed example, a case in which the high computing capability is required may be considered as a case in which the terminal requests a generative AI based service and PDU session establishment is required. Herein, the above-mentioned first value may be included in the PDU session establishment request and thus, a network node considering the high computing capability may be selected.

As another example, the computing capability-related information may be information indicating that the high computing capability and the high computing resource are required. As a detailed example, when the parameter is set to the first value as the computing capability-related information, a network node with the high computing capability may be selected in conjunction with the established PDU session. On the other hand, when the parameter is set to the second value as the computing capability-related information, the network node may be selected on the basis of whether it is possible to perform a service connection such that the established PDU session is the same as before. This is as described above.

As a detailed example, when the parameter is set to a third value as the computing capability-related information, the established PDU session may be a case in which a very low computing capability is required. Alternatively, when the parameter is set to the third value as the computing capability-related information, the service may fail to be processed in a data network and it may be indicated that data processing is required in an edge node in the network. As an example, when service processing for Internet of things (IoT) based sensor data is performed, it may be indicated that a very low computing capability is required or it may be indicated that data processing is required in the edge node, but not limited to the embodiment.

As another example, detailed parameters associated with the computing capability may be included in the PDU session establishment request message. As a detailed example, at least any one of priority information associated with the computing capability, ensured computing capability information, latency time-related information, packet error-related information, and the other information may be included. As an example, the priority information associated with the computing capability may indicate a priority based on the computing capability. In other words, an establishment request with a high priority may be first assigned to a network node and system with the high computing capability to be processed.

Furthermore, minimum computing capability information which should be ensured may indicate a minimum computing capability necessary in conjunction with the service. As an example, the information may be set to a low value in conjunction with an existing service and the information may be set to a high value for a service requiring the high computing capability as a new service. Furthermore, at least any one of latency time-related information considering the computing capability and packet error-related information considering the computing capability may be further included, but not limited thereto.

As another example, the computing capability information may be information included in QoS-related information in conjunction with the PDU session establishment request message. The QoS-related information may include information about at least any one of a bandwidth, latency, a packet loss rate, and reliability. Herein, computing capabilities information may be further included as QoS-related information. As an example, as described above, the computing capabilities information may be included as the QoS-related information with regard to a service requiring the high computing capability as a service (e.g., generative AI) requiring the high computing capability or the high computing resource. As an example, when traffic for the generative AI service request is generated in the terminal, there is a need to be processed via networks, each of which has the high computing capability and the high computing resource, and a parameter or a setting value therefor may be applied to the QoS-related information.

Furthermore, as an example, conventionally, enhanced mobile broadband (eMBB), ultra-reliable low-latency communication (URLLC), and massive machine type communication (mMTC) may be considered as a service provided in conjunction with PDU session establishment. Herein, a service considering the high computing capability may be further considered in conjunction with PDU session establishment and may not be limited to a specific name. In other words, provision of a service in which the high computing capability should be ensured as a specific service may be considered. Furthermore, a network slice may also be established based on those described above. As an example, conventionally, an eMBB slice for ensuring a high bandwidth, a URLLC slice for ensuring ultra-reliable low latency and high reliability, and an mMTC slice for supporting massive connection density may be considered. Herein, a high computing capability slice for ensuring high computing capability support may be further considered. In other words, a slice considering the high computing capability may be established as a specific network slice. The slice name may not be limited to a specific name.

As another example, an identifier indicating a service requiring the high computing capability may be added to a QoS Identifier (e.g., a 5G QoS Identifier). An identifier for a service indicating that the high computing capability is required as the same service as generative AI may be added to the QoS Identifier. As a result, a service requiring the high computing capability may be indicated. In other words, a computing capability-related setting may be added in conjunction with QoS.

As an example, when the computing capability-related setting is performed as one of QoS-related parameters, a setting value for an allowed computing capability may be determined. Herein, the setting value for the allowed computing capability may be, but is not limited to, a setting value based on the same processing performance as a CPU or a GPU. As a detailed example, a setting value for the computing capability may be set to be high in a service of the same type as the generative AI. As another example, it may be possible to set a priority for the service requiring the high computing capability and is not limited to a specific form.

Herein, referring to FIG. 10, the AMF 1030 may select an SMF 1040 with regard to computing capability information. As an example, computing capabilities for the entire network in the SMF 1040 and nodes managed by the SMF 1040 may be different from each other. The AMF 1030 may select the SMF 1040 with regard to a computing capability requirement with regard to the above-mentioned points. As an example, when the high computing capability is required, the AMF 1030 may select the SMF 1040 constituting a network capable of supporting the high computing capability among the SMFs 1040 and may provide a service requiring the high computing capability based on it, but not limited thereto. Furthermore, other items may be performed to be the same as the operations of FIG. 9.

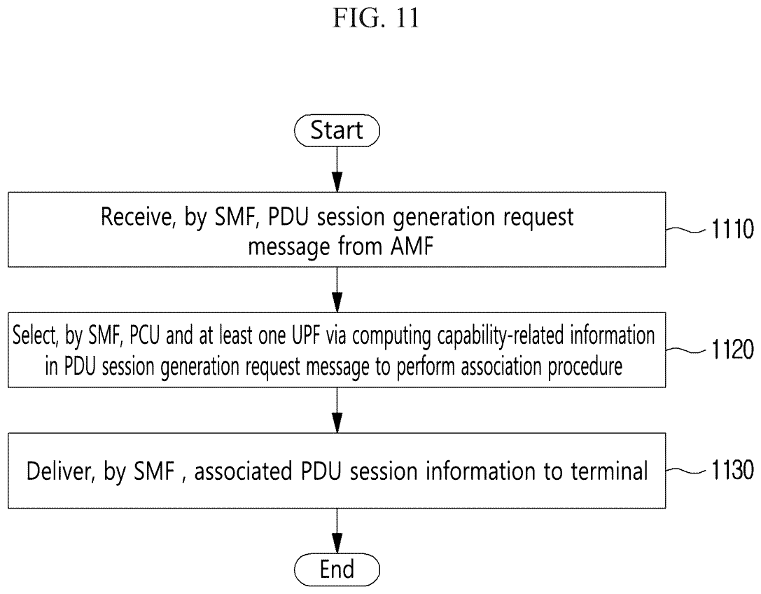

FIG. 11 is a flowchart illustrating a method for establishing a PDU session in an SMF according to an embodiment. Referring to FIG. 11, the SMF may receive a PDU session generation request message from an AMF (S1110). Herein, the PDU session generation request message may include the above-mentioned computing capability-related information (or the computing capability-related parameter). Thereafter, the SMF may select a PCF and at least one UPF via the computing capability-related information in the PDU session generation request message to perform an association procedure (S1120). As an example, the computing capability-related information may be the same as FIGS. 9 and 10 described above, but may not be limited thereto. Thereafter, the SMF may deliver associated PDU session information to a terminal via a base station and as a result, a PDU session may be established (S1130).

As an example, the SMF may obtain computing capability information from each of a plurality of UPFs. The SMF may determine at least one UPF with computing capability information of a predetermined level or more among the plurality of UPFs based on the computing capability information received from each of the plurality of UPFs. As an example, the predetermined level may be a threshold or the other parameter set for the computing capability information. In detail, the computing capability information may be represented with a digitalized value and may be determined such that the UPFs, each of which has a computing capability of a predetermined value or more, provide high-performance computing capability based service.

In other words, the SMF may select at least one UPF with the computing capability information of the predetermined level or more among the plurality of UPFs based on the computing capability information received from each of the plurality of UPFs depending on high-performance computing capability request information included in the PDU session generation request message.

As another example, the high-performance computing capability request information included in the PDU session generation request message may indicate whether a service corresponding to the PDU session generation request message is a service requiring a high-performance computing capability. As an example, whether the service is the service requiring the high-performance computing capability may be verified based on whether the high-performance computing capability request information is included in the PDU session generation request message.

As another example, when the high-performance computing capability request information included in the PDU session generation request message is a first value, the high-performance computing capability request information may indicate that the service is the service requiring the high-performance computing capability. On the other hand, when the high-performance computing capability request information is a second value, it may be a legacy service. In other words, a network node considering a connection like before may be determined and a service may be provided.

As another example, a UPF management function may be considered as a separate network function for managing the plurality of UPFs. The UPF management function may be connected with the plurality of UPFs to obtain information about each. Herein, computing capability information about each UPF may be included in information about each of the UPFs. In other words, the UPF management function may be connected with the plurality of UPFs to obtain computing capability information from each of the plurality of UPFs and may determine at least one UPF for the PDU session generation request message based on the obtained computing capability information. In other words, the UPF management function may select UPFs of the predetermined level or predetermined value or more with regard to the service requiring the high-performance computing capability among the plurality of UPFs. Thereafter, the UPF management function may deliver information about the determined at least one UPF to the SMF. The SMF may provide the service requiring the high-performance computing capability based on the information about the at least one UPF. Herein, as an example, the UPF management function may manage the UPF in real time. In detail, the UPF management function may obtain computing capability information of a current UPF with regard to data processed in the UPF. As an example, when there is a large amount of data processing because there are many services provided to a specific UPF, the UPF may be a UPF with a computing capability of the predetermined level or predetermined value or less and may be excluded from a UPF for the service requiring the high-performance computing capability in the case described above. In contrast, a UPF, the computing capability of which remains, because there is not much data to process may have the predetermined level or predetermined value or more and thus, may be included in the UPF for the service requiring the high-performance computing capability.

Furthermore, the high-performance computing capability request information included in the PDU session generation request message may indicate whether the service corresponding to the PDU session generation request message is the service requiring the high-performance computing capability. Herein, the SMF may deliver the high-performance computing capability request information to a PCF. The PCF may obtain policy information determined via the high-performance computing capability request information to determine at least one UPF. In detail, policy information based on the high-performance computing capability may be included in the PFC. The policy information may include a threshold or threshold level information about a computing capability of each node with regard to the service requiring the high-performance computing capability. Alternatively, information about a network node which should be included in service provision may be included in the policy information and is not limited to a specific form.

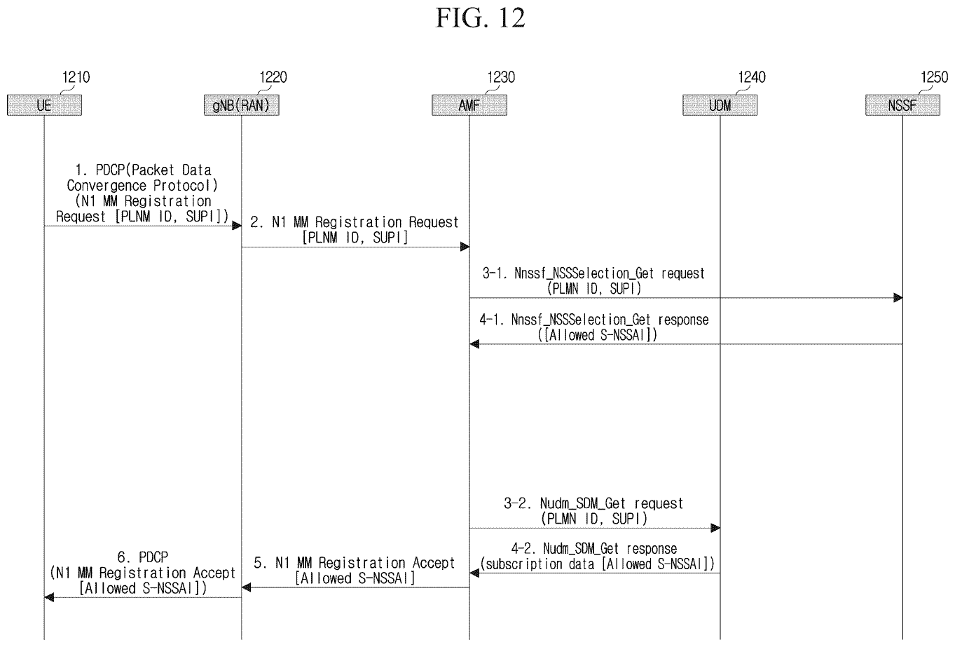

FIG. 12 is a drawing illustrating a method for allocating an S-NSSAI according to an embodiment. Referring to FIG. 12, single network slice selection assistance information (S-NSSAI) may be allocated based on a service required by a terminal. The S-NSSAI may be a value indicating a slice or a service type, which may be composed of a slice/service type (SST) and a value (a slice differentiator (SD)) for differentiating each slice. In other words, the S-NSSAI may refer to a slice type and a slice allocated according to the slice type. Herein, the slice type may include, but is not limited to, an enhanced mobile broadband (eMBB) type considering high-speed data transfer (e.g., AR/VR), an ultra-reliable low latency communications (URLLC) type considering ultra-reliable low latency/high reliability (e.g., autonomous driving), and massive machine type communications (mMTC) considering a large-scale IoT service (e.g., a sensor network).

Referring to FIG. 12, user equipment (UE) 1210 may deliver a registration request message (N1 MM Registration Request) to an AMF 1230 via a base station 1220. Herein, the registration request message may include a public land mobile network identifier (PLNM ID) and a subscription permanent identifier (SUPI). As an example, requested NSSAI may be included in the registration request message. The AMF 1230 may transmit a slice selection request to a network slice selection function (NSSF) depending on the requested NSSAI. On the other hand, when the requested NSSAI is not included in the registration request message, the AMF 1230 may determine a network slice with reference to subscription information in a UDM 1240.

When the AMF 1230 transmits the slice selection request to the NSSF 1240, the PLMN ID and the SUPI, which described above, may be included in the request message (e.g., Nnssf_NSSSelection_Get request) transmitted by the AMF 1230. Furthermore, as an example, requested NSSAI may be further included in the request message transmitted by the AMF 1230.

An NSSF 1250 may verify a slice capable of being provided based on subscription information and authority of the UE and the other information via the PLMN ID and the SUPI. The AMF 1230 may receive a response message (e.g., Nnssf_NSSSelection_Get response) from the NSSF 1250 in response to the slice selection request. Herein, allowed S-NSSAI as an allowed network slice may be included in the response message. As an example, the allowed S-NSSAI may be as in Table 2 below. In Table 2, allowedSnssai may be an allowed network slice in a serving PLMN, which may include an S-NSSAI value, and may be, but is not limited to, a value for any one of the eMBB type, the URLLC type, and the mMTC type, which are described above. nsInformationList may include network slice Instance-related detailed information provided by the NSSF 1250. mappedHomeSnssai may be a value used in only a roaming situation, which may include a mapped S-NSSAI value in a home PLMN, for the S-NSSAI of the serving PLMN. Furthermore, as an example, rejected S-NSSA as a rejected network slice and cause information (cause value) may be further included in the response message.

TABLE 2

| | | | Cardi- | |
|---|---|---|---|---|
| Attribute name | Data type | P | nality | Description |
| allowedSnssai | Snssai | M | 1 | This IE shall contain |
| | | | | the allowed S- |
| | | | | NSSAI in the |
| | | | | serving PLMN. |
| nsiInformationList | array(NsiInfor- | O | 1. . . N | This IE may be |
| | mation) | | | present when the |
| | | | | NSSF provides the |
| | | | | Allowed NSSAI |
| | | | | information to the |
| | | | | NF service |
| | | | | consumer (e.g., |
| | | | | AMF). If present, |
| | | | | this IE shall include |
| | | | | the information |
| | | | | related to the |
| | | | | network slice |
| | | | | instance |
| | | | | corresponding to the |
| | | | | allowed S-NSSAI. |
| mappedHomeSnssai | Snssai | O | 0 . . . 1 | When present, this |
| | | | | IE shall contain the |
| | | | | mapped S-NSSAI |
| | | | | value of home |
| | | | | network |
| | | | | corresponding to the |
| | | | | allowed S-NSSAI in |
| | | | | the serving PLMN. |

As another example, when there is no allowed S-NSSAI as the allowed network slice in the response message received from the NSSF 1250, the AMF 1230 may transmit a subscription data search request for the S-NSSAI to the UDM 1240. Herein, the PLMN ID and the SUPI may be included in the search request. The UDM 1240 may transmit the subscription data to the AMF 1230 via the PLMN ID and the SUPI. An allowed S-NSSAI which is an allowed network slice may be included in the subscription data. As an example, the allowed S-NSSAI which is the allowed network slice in the subscription data may be determined based on Tables 3 to 5 below. In detail, S-NSSAI information to which the UE 1210 subscribes may be verified according to a subscription data type and information about it may be delivered to the AMF 1230 via the response message, but may not be limited thereto.

TABLE 3

| Subscription | | |
|---|---|---|
| data type | Field | Description |
| Access and Mobility | GPSI List | List of the GPSI (Generic Public |
| Subscription data | | Subscription Identifier) used both |
| (data needed for UE | | inside and outside of the 3GPP |
| Registration and | | system to address a 3GPP |
| Mobility | | subscription (see NOTE 9). |
| Management) | Internal | List of the subscribed internal |
| | Group ID- | group(s) that the UE belongs to. |
| | list | |
| | Subscribed | The maximum aggregated uplink and |
| | UE-AMBR | downlink MBRs to be shared across |
| | | all Non-GBR QoS Flows according |
| | | to the subscription of the user. |
| | Subscribed | List of maximum aggregated uplink |
| | UE-Slice- | and downlink MBRs to be shared |
| | MBR(s) | across all GBR and Non-GBR QoS |
| | | Flows related to the same S-NSSAI |
| | | according to the subscription of |
| | | the user. There is a single uplink |
| | | and a single downlink value per S- |
| | | NSSAI. |
| | Subscribed | The Network Slices that the UE |
| | S-NSSAIS | subscribes to. In the roaming |
| | | case, it indicates the subscribed |
| | | Network Slices applicable to the |
| | | Serving PLMN (NOTE 11, NOTE |
| | | 24). |

TABLE 4

| Subscription | | |
|---|---|---|
| data type | Field | Description |
| Slice Selection | Subscribed | The Network Slices that the UE |
| Subscription data | S-NSSAIs | subscribes to. In roaming case, |
| (data needed for | | it indicates the subscribed |
| Slice Selection) | | network slices applicable to |
| | | the serving PLMN (NOTE 11, |
| | | NOTE 24). |
| | Default | The Subscribed S-NSSAIs |
| | S-NSSAIs | marked as default S-NSSAI. In |
| | | the roaming case, only those |
| | | applicable to the Serving PLMN |
| | | (NOTE 12). |
| | S-NSSAIs subject | The Subscribed S-NSSAIs |
| | to Network Slice- | marked as subject to NSSAA. |
| | Specific | |
| | Authentication and | |
| | Authorization | |
| | Network Slice | Optionally, for each S-NSSAI in |
| | Simultaneous | the Subscribed S-NSSAIs, the |
| | Registration Group | one or more value of Network |
| | (NSSRG) | Slice Simultaneous Registration |
| | Information | Group(s) (NOTE 11) associated |
| | | with the S-NSSAI. |
| | Network Slice | Optionally, if the Subscribed |
| | validity time | S-NSSAI is temporarily |
| | information | available network slice, one |
| | | validity time is associated |
| | | with this S-NSSAI. |
| SMF Selection | SUPI | Key |
| Subscription data | SMF Selection Subscription data contains one or | |
| (data needed for | more S-NSSAI level subscription data: | |
| SMF Selection) | S-NSSAI | Indicates the value of the S- |
| | | NSSAI. |
| | Subscribed DNN | List of the subscribed DNNs for |
| | list | the UE (NOTE 1, NOTE 24). |
| | Default DNN | The default DNN if the UE does |
| | | not provide a DNN (NOTE 2). |

Thereafter, the AMF 1230 may deliver a registration request response message (e.g., N1 MM registration accept) including the allowed S-NSSAI to the UE 1210 via the base station 1220. The UE 1210 may transmit a PDU session request based on a list of allowed S-NSSAIs.

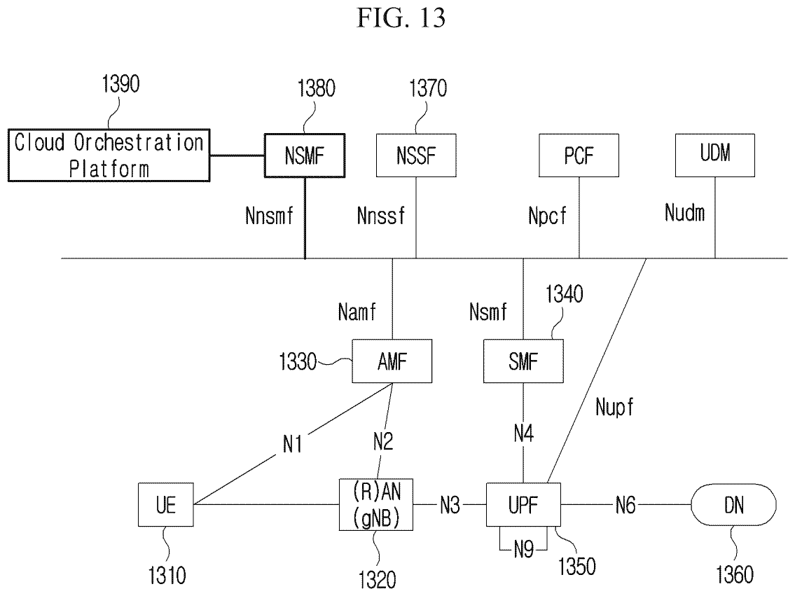

FIG. 13 is a drawing illustrating a structure including a network slice management function according to an embodiment.

Referring to FIG. 13, a UE 1310, a base station 1320, an AMF 1330, an SMF 1340, a UPF 1350, and a DN 1360 may operate via a mutual interface based on the structure of FIG. 6 or 7 described above and is not limited to a specific form. Herein, a network slice management function (NSMF) 1380 may be further included in the structure of FIG. 6 or 7. The NSMF 1380 may be a network function for managing a network slice. In detail, the NSMF 1380 may manage a network slice or a network slice instance (NSI). The NSMF 1380 may perform an operation of generating, changing, or removing a network slice or a network slice instance and may perform management for the network slice based on it. Herein, the NSMF 1380 may receive a network slice request from an NSSF 1370. The NSMF 1380 may determine and generate a slice matched with the request depending on the network slice request received from the NSSF 1370. As an example, the NSMF 1380 may determine and generate a slice with regard to a slice requirement (or a service requirement) depending on the network slice request. Herein, the generated network slice may be the existing type and the eMBB, URLLC, or mMTC type, which are described above. As another example, the generated network slice type may be a type requiring a high computing capability. In detail, as described above, when the same service as generative AI is requested, the network slice type may be determined as a network slice type requiring the high computing capability. As another example, the network slice type may be a network slice type including cloud native metadata. A description will be given below of it. After the slice network type is determined, pieces of information matched with a resource or service level for the determined slice network type and the other requirements may be determined.

As an example, the NSMF 1380 may consider a slice or a slice instance including cloud native metadata. The cloud native metadata may refer to data necessary with regard to operating based on a cloud native system. The cloud native system may be a system which provides a network function and the other components via visualization via a cloud environment. In other words, the cloud native system may dynamically determine a network function or respective components in a RAN, a core network, or a delivery network, thus having a flexible structure. Thus, the cloud native system may dynamically determine a necessary network function or component to provide a necessary service.

Herein, the cloud native metadata may be data necessary when the network function or the components are dynamically allocated in the cloud native system. As a detailed example, the metadata may include resource metadata for a CPU or a memory as a computing capability, network metadata including QoS, policy information, or the like of a network, and metadata for a network function or a component dynamically allocated, and is not limited to a specific form. As an example, the cloud native metadata may be configured based on each attribute like Table 6 below. Referring to Table 6, the cloud native metadata may include location information in which a service is provided, latency information required in the service, cloud type information, and pieces of necessary information for configuring a network slice determined based on the cloud native system as the other pieces of information.

TABLE 6

| Attribute | Description |
|---|---|
| Location | Refer to the service providing location and is the value such |
| | as Edge or Core |
| Latency | Service latency: Ultra-low, low, normal, slow, . . . |
| Cloud type | Cloud type: k8s, . . . |
| . . . | . . . |

In other words, the cloud native metadata may be information necessary with regard to the cloud native system. Herein, the network slice including the cloud native metadata may be considered. The network slice including the cloud native metadata may be a network slice configured based on the cloud native metadata which is information necessary according to the cloud native system. The network slice may be managed based on the cloud native metadata.

The NSMF 1380 may be connected with cloud orchestration 1390 with regard to the slice including the cloud native metadata. The cloud orchestration 1390 may be, but is not limited to, a configuration to determine a resource and the other requirements when determining the network slice including the cloud native metadata based on the cloud native metadata.

Furthermore, as an example, a network slice requiring high computing power may be further included. When the network slice requiring the high computing power is requested by the terminal, the NSMF 1380 may determine the network slice requiring the high computing power and may provide information about it. Herein, the NSMF 1380 may configure a network slice depending on the above-mentioned cloud orchestration 1390 and another orchestration. As a detailed example, respective nodes included in data transfer based on the network slice requiring the high computing power needs to have computing power or a resource of a predetermined value or more. The cloud orchestration 1390 or the other orchestration may dynamically configure each component for at least any one of the RAN, the core network, and the delivery network based on the network slice requiring the high computing power. In other words, nodes with the computing power or the resource of the predetermined value or more may be configured to be included in the network slice. However, this is merely an example, but may not be limited thereto.

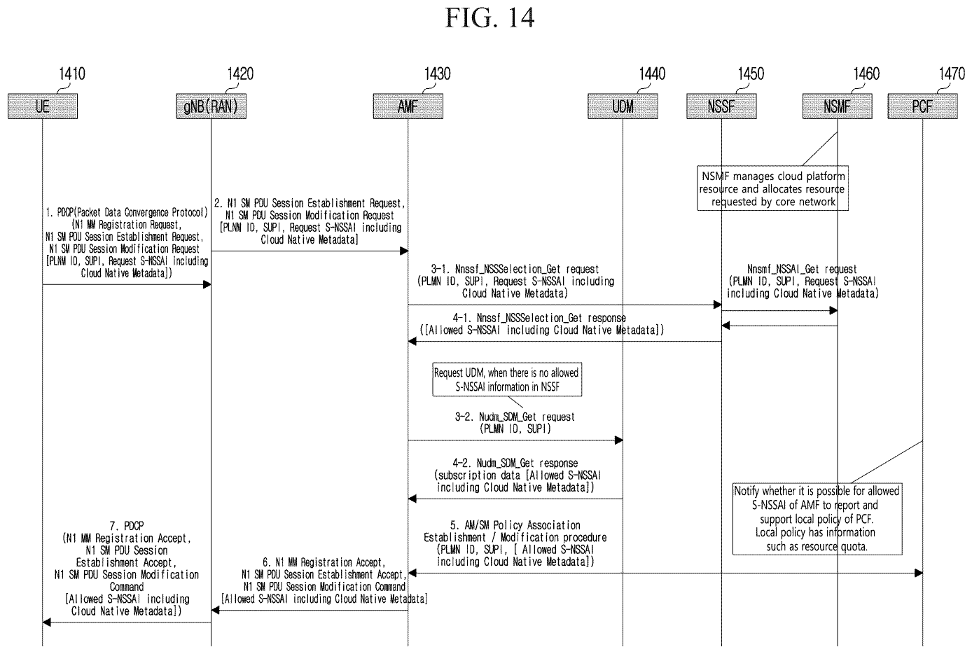

FIG. 14 is a drawing illustrating a method for requesting an S-NSSAI including cloud native metadata according to an embodiment. FIG. 14 may be a method for requesting an S-NSSAI including cloud native metadata in an operation based on FIG. 12 described above.

Referring to FIG. 14, user equipment (UE) 1410 may deliver a registration request message (N1 MM Registration Request) to an AMF 1430 via a base station 1420. Herein, the registration request message may include a PLNM ID and an SUPI as described above in FIG. 12. As an example, the registration request message may include requested NSSAI. The AMF 1430 may transmit a slice selection request to an NSSF 1450 depending on the requested NSSAI. Herein, information for requesting S-NSSAI including cloud native metadata may be included in the requested NSSAI. As another example, information for requesting the S-NSSAI requiring high computing power may be included in the requested NSSAI. As an example, “Request S-NSSAI including Cloud Native Metadata” as the information for requesting the S-NSSAI including the cloud native metadata may be included in the registration request message. The message may be delivered to the AMF 1430 via the base station 1420. Furthermore, the registration request message may include the information for requesting the S-NSSAI requiring the high computing power and is not limited to a specific form.

The UE 1410 may transmit a request for receiving a service via the network slice including the cloud native metadata based on the cloud native system or the network slice requiring the high computing power.

Herein, when the AMF 1430 transmits the network slice selection request to the NSSF 1450, a PLMN ID and an SUPI may be included in the request message (e.g., Nnssf_NSSSelection_Get request) transmitted by the AMF 1430. As an example, information for requesting the S-NSSAI including the cloud native metadata (or the S-NSSA) requiring the high computing power) may be included in the request message transmitted by the AMF 1430.

The NSSF 1450 may verify a slice capable of being provided based on subscription information and authority information of the UE 1410 based on the PLMN ID. Herein, the NSSF 1450 may transmit a request S-NSSAI to an NSMF 1460. The NSMF 1460 may determine and deliver a network slice to the NSSF 1450. In detail, the NSSF 1450 may deliver an S-NSSAI request including the cloud native metadata (e.g., Request S-NSSAI including Cloud Native Metadata) to the NSMF 1460. As another example, the NSSF 1450 may deliver an S-NSSAI request requiring the high computing power to the NSMF 1460. As described above, the NSMF 1460 may be connected with the cloud orchestration or the other orchestration. The cloud orchestration (or the other orchestration) may manage a component for at least any one of a RAN, a core network, and a delivery network depending on the cloud native system and may determine respective components corresponding to the network slice request. Furthermore, the cloud orchestration (or the other orchestration) may manage a resource based on the cloud native system, may determine the requested resource or the other information, and may deliver S-NSSAI information including the cloud native metadata (or S-NSSAI information requiring the high computing power). The AMF 1430 may receive a response message (e.g., Nnssf_NSSSelection_Get response) from the NSSF 1450 in response to the network slice selection request. Herein, allowed S-NSSAI as an allowed network slice may be included in the response message. As an example, the allowed S-NSSAI may indicate S-NSSAI including the cloud native metadata (or S-NSSAI requiring the high computing capability). Herein, with regard to indicating the S-NSSAI including the cloud native metadata, allowedSnssai in Table 2 described above may further include a network slice including the cloud native metadata as an allowed network slice value in a serving PLMN or a network slice requiring the high computing power.

As another example, when there is no allowed S-NSSAI as the allowed network slice in the response message received from the NSSF 1450, the AMF 1430 may transmit a subscription data search request for the S-NSSAI to a UDM 1440. Herein, a PLMN ID and an SUPI may be included in the search request. The UDM 1440 may transmit the subscription data to the AMF 1430 via the PLMN ID and the SUPI. An allowed S-NSSAI which is an allowed network slice may be included in the subscription data. Herein, the allowed S-NSSAI may indicate an S-NSSAI including the cloud native metadata (or an S-NSSAI requiring the high computing capability). Herein, with regard to indicating the S-NSSAI including the cloud native metadata (or the S-NSSAI requiring the high computing power), a network slice including the cloud native metadata as the allowed network slice value in Tables 3 to 5 above (or the network slice requiring the high computing power) may be further included.

As another example, the AMF 1430 may verify whether it is possible to perform resource allocation to the network slice including the cloud native metadata using the allowed S-NSSAI corresponding to the PLMN ID and the SUPI from a PCF 1470 via an AM/SM policy association establishment/modification procedure) The PCF 1470 may determine whether it is possible to perform resource allocation for the network slice including the cloud native metadata (or the network slice requiring the computing power) depending on a local policy and may deliver the information to the AMF 1430.

As another example, the PCF 1470 may deliver policy information including information about a node which provides the service with regard to the network slice to the AMF 1430. Respective nodes may be flexibly determined in the cloud native system. The PCF 1470 may deliver information about the nodes which provide the service based on the local policy to the AMF 1430. Thereafter, the service for the network slice may be provided via the nodes determined according to the local policy. The AMF 1430 may deliver at least any one of a registration request response message (e.g., N1 MM registration accept) including the allowed S-NSSAI, a PDU session establishment allowance message, and a PDU session change command message to the UE 1410 via the base station 1420. A session connection may be performed via those described above.

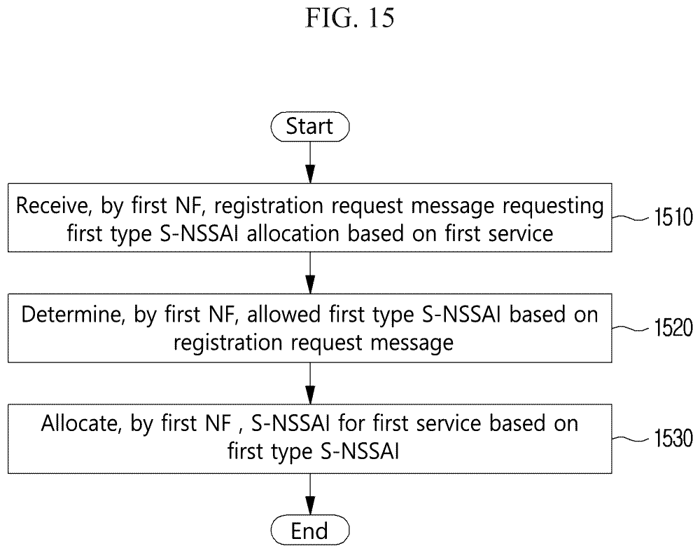

FIG. 15 is a drawing illustrating a method for requesting an S-NSSAI according to an embodiment.

Referring to FIG. 15, a first NF may receive a registration request message requesting first type S-NSSAI allocation based on a first service (S1510). As an example, the first NF may be an AMF and the AMF may obtain a registration message requesting the first type S-NSSAI allocation from a terminal. In other words, the registration request message may be delivered to the AMF via a base station. Herein, the first NF may determine an allowed first type S-NSSAI based on the registration request message (S1520). Thereafter, the first NF may allocate an S-NSSAI for the first service based on the first type S-NSSAI (S1530). As an example, the first NF may deliver a first type S-NSSAI allocation request to a second NF to determine an allowed S-NSSAI. Herein, the second NF may be an NSSF. As another example, the first NF may obtain and determine the allowed S-NSSAI based on subscription information from a UDM. This is as described above.

Herein, as an example, the first type S-NSSAI may be an S-NSSAI including cloud native metadata. The S-NSSAI including the cloud native metadata may be an S-NSSAI including cloud native system-related information in a network which operates based on a cloud native system. Furthermore, the first NF may deliver a request message including the first type S-NSSAI allocation request to the second NF.

The first NF may receive a response message including the allowed first type S-NSSAI determined in the second NF based on the first type S-NSSAI allocation request. Herein, the second NF may transmit the first type S-NSSAI allocation request to a third NF connected with cloud orchestration. As an example, the third NF may be, but is not limited to, an NSMF. The third NF may obtain at least one allowed first type S-NSSAI in which cloud native metadata is set by the cloud orchestration. The information may be delivered to the first NF via the second NF.

As another example, the first type S-NSSAI may be an S-NSSAI for providing a high-performance computing capability based service based on the first service. The S-NSSAI for providing the high-performance computing capability based service may be an S-NSSAI to select at least one network node having a computing capability of a predetermined level or more to provide the first service. Herein, the first NF may deliver a request message including the first type S-NSSAI allocation request to the second NF. The first NF may receive a response message including the allowed first type S-NSSAI determined in the second NF based on the first type S-NSSAI allocation request. Furthermore, the second NF may transmit the first type S-NSSAI allocation request to the third NF connected with the cloud orchestration. Thereafter, the third NF may obtain at least one allowed first type S-NSSAI in which configuration information of the first type S-NSSAI is set by the orchestration. The information may be delivered to the first NF via the second NF.

Meanwhile, the embodiment of the present disclosure is not implemented only through the device and the method described above, and may be implemented through a program to execute functions corresponding to the configurations of the embodiment of the present disclosure or a recordable medium having the program recorded therein. The implementation may be easily realized by those having ordinary skill in the art based on the description of the above-mentioned embodiment. In detail, the method (e.g., the network management method, the data transmission method, the transmission schedule generation method, or the like) according to an embodiment of the present disclosure may be implemented in the form of a program command capable of being performed via various computer means to be recorded in a computer-readable medium. The computer-readable medium may include program commands, data files, data structures, or the like alone or in combination. The program commands recorded in the computer-readable medium may be specially designed and configured for the embodiment of the present disclosure or may also be known and available to those skilled in computer software. The computer-readable medium may include a hardware device configured to store and perform the program commands. For example, the computer-readable medium may include magnetic media, such as a hard disk, a floppy disk, and a magnetic tape, optical media, such as a CD-ROM and a DVD, magneto-optical media, such as a floptical disk, read only memories (ROMs), random access memories (RAMs), flash memories, and the like. The program commands may include not only a mechanical code, such as things generated by a compiler, but also a high-level language code executable by a computer using an interpreter or the like.

The present disclosure may provide the method for managing the PDU session.

The present disclosure may provide the method for managing the PDU session with regard to the computing capability.

The present disclosure may provide the method for allocating the network slice including the cloud native metadata.

The present disclosure may provide the method for allocating the network slice requiring the high-performance computing capability.

The effects that are achieved through embodiments of the present disclosure may not be limited to what has been particularly described herein, and other advantages not described herein may be more clearly derived and understood from the following detailed description for the embodiments of the present disclosure by persons skilled in the art. In other words, unintended effects according to the execution of the configuration described in the present disclosure may also be derived by those skilled in the art from embodiments of the present disclosure.

Although embodiments of the present disclosure have been described in detail, the scope of the present disclosure is not limited by such embodiments. Various changes and modifications using the basic concept of the present disclosure defined in the accompanying claims by those having ordinary skill in the art should be construed to belong to the scope of the present disclosure.

What is claimed is:

1. A method for establishing a protocol data unit (PDU) session, the method comprising:
receiving, by a session management function (SMF), a PDU session generation request message from an access management function (AMF), the PDU session generation request message including high-performance computing capability request information;
selecting, by the SMF, a policy control function (PCF) and at least one user plane function (UPF) based on a PDU session establishment request to perform an association procedure; and
delivering, by the SMF, associated PDU session information to a terminal via a base station.

2. The method of claim 1, wherein the SMF obtains computing capability information from each of a plurality of UPFs; and
wherein the SMF selects the at least one UPF with computing capability information of a predetermined level or more among the plurality of UPFs based on the computing capability information received from each of the plurality of UPFs depending on high-performance computing capability request information included in the PDU session generation request message.

3. The method of claim 2, wherein the high-performance computing capability request information included in the PDU session generation request message indicates whether a service corresponding to the PDU session generation request message is a service requiring a high-performance computing capability;
wherein the high-performance computing capability request information indicates that the service corresponding to the PDU session generation request message is the service requiring the high-performance computing capability, when the high-performance computing capability request information is a first value; and
wherein the high-performance computing capability request information indicates a legacy service, when the high-performance computing capability request information is a second value.

4. The method of claim 2, wherein the SMF is connected with a UPF management function and the UPF management function is connected with the plurality of UPFs to obtain the computing capability information from each of the plurality of UPFs and determines the at least one UPF for the PDU session generation request message based on the obtained computing capability information; and
wherein the SMF obtains information about the at least one UPF determined from the UPF management function.

5. The method of claim 1, wherein the high-performance computing capability request information included in the PDU session generation request message indicates whether a service corresponding to the PDU session generation request message is a service requiring a high-performance computing capability; and
wherein the SMF delivers the high-performance computing capability request information to the PCF and the PCF obtains policy information determined via the high-performance computing capability request information to determine the at least one UPF.

6. A method for allocating single network slice selection assistance information (S-NSSAI), the method comprising:
receiving, by a first network function (NF), a registration request message requesting first type S-NSSAI allocation based on a first service;
determining, by the first NF, allowed first type S-NSSAI based on the registration request message; and
allocating, by the first NF, the S-NSSAI for the first service based on the allowed first type S-NSSAI.

7. The method of claim 6, wherein the first type S-NSSAI is an S-NSSAI including cloud native metadata; and
wherein the S-NSSAI including the cloud native metadata is an S-NSSAI including cloud native system-related information in a network which operates based on a cloud native system.

8. The method of claim 7, wherein the first NF delivers a request message including a first type S-NSSAI allocation request to a second NF; and
wherein the first NF receives a response message including the allowed first type S-NSSAI determined in the second NF based on the first type S-NSSAI allocation request.

9. The method of claim 8, wherein the second NF transmits the first type S-NSSAI allocation request to a third NF connected with cloud orchestration and obtains at least one allowed first type S-NSSAI in which the cloud native metadata is set by the cloud orchestration; and
wherein the first NF obtains the allowed first type S-NSSAI from the second NF.

10. The method of claim 6, wherein the first type S-NSSAI is an S-NSSAI for providing a high-performance computing capability based service based on the first service; and
wherein the S-NSSAI for providing the high-performance computing capability based service is an S-NSSAI to select at least one network node having a computing capability of a predetermined level or more to provide the first service.

11. The method of claim 10, wherein the first NF delivers a request message including a first type S-NSSAI allocation request to a second NF; and
wherein the first NF receives a response message including the allowed first type S-NSSAI determined in the second NF based on the first type S-NSSAI allocation request.

12. The method of claim 11, wherein the second NF transmits the first type S-NSSAI allocation request to a third NF connected with orchestration and obtains at least one allowed first type S-NSSAI in which configuration information of the first type S-NSSAI is set by the orchestration; and
wherein the first NF obtains the allowed first type S-NSSAI from the second NF.

13. An apparatus for performing protocol data unit (PDU) session establishment, the apparatus comprising:
a memory storing at least one program;
a transceiver configured to transmit and receive at least one signal; and
a processor configured to execute the at least one program stored in the memory,
wherein the processor is configured to:
receive a PDU session generation request message from an access management function (AMF), the PDU session generation request message including high-performance computing capability request information;
select a policy control function (PCF) and at least one user plane function (UPF) based on a PDU session establishment request to perform an association procedure; and
deliver associated PDU session information to a terminal via a base station.

14. An apparatus for allocating single network slice selection assistance information (S-NSSAI), the apparatus comprising:
a memory storing at least one program;
a transceiver configured to transmit and receive at least one signal; and
a processor configured to execute the at least one program stored in the memory,
wherein the processor is configured to:
receive a registration request message requesting first type S-NSSAI allocation based on a first service;
determine an allowed first type S-NSSAI based on the registration request message; and
allocate an S-NSSAI for the first service based on the allowed first type S-NSSAI.
